(19) United States
(12) Patent Application Publication
(10) Pub. No.: US 2015/0234747 A1
(43) Pub. Date: Aug. 20, 2015

(54) CACHE MEMORY CONTROLLER AND CACHE MEMORY CONTROL METHOD

(71) Applicant: MITSUBISHI ELECTRIC CORPORATION, Tokyo (JP)

(72) Inventors: Saori Tanaka, Tokyo (JP); Junko Kijima, Tokyo (JP); Masahiro Naito, Tokyo (JP)

(73) Assignee: MITSUBISHI ELECTRIC CORPORATION, Tokyo (JP)

(21) Appl. No.: 14/411,709

(22) PCT Filed: Apr. 16, 2013
(86) PCT No.: PCT/JP2013/061244

§ 371 Date: May 4, 2015

(30) Foreign Application Priority Data
Aug. 22, 2012 (JP) 2012-183338

(51) Int. Cl. G06F 12/08

(52) U.S. Cl. CPC G06F 12/0875; G06F 2212/1024; G06F 2212/452

(57) ABSTRACT

A cache memory controller (100) connected to a main memory (10) having an instruction area storing a first program and a data area storing data used by a specific instruction included in the first program, and to an access master (1) for executing instructions included in the first program. The cache memory controller is provided with a cache memory (110) for storing a portion of the data in the main memory (10), and a data processing unit (140) that, prior to execution of the specific instruction by the access master (1), and in accordance with transfer scheduling information including the starting address of the specific instruction, calculates an access interval on a basis of the number of instruction steps remaining from the address of the instruction currently being executed by the access master (1) to the starting address of the specific instruction, and transfers data used by the specific instruction from the main memory (10) to the cache memory (110) at this access interval.

### TECHNICAL FIELD

The present invention relates to a cache memory controller and a cache memory control method.

### BACKGROUND ART

The amounts of data in the computer programs, images, and so on that devices deal with has been increasing over recent years, and the capacities of the hard disks and main memories installed in the devices have been increasing as well. A main memory is divided into an instruction area and a data area. Program instructions and other instructions are stored in the instruction area; image data and other data used in processing by the instructions are stored in the data area. Since the main memory operates at a lower cycle speed than the CPU or other access master, a cache memory that can be accessed at high speed is generally employed. By accessing the cache memory, the access master can read and write data faster.

Cache memories, however, are expensive and have a low capacity per unit area, so in most cases it would be difficult to replace the entire main memory with a cache memory. The method therefore adopted is to transfer part of the main memory data into the cache memory. Transfers from main memory to cache memory are carried out in units of cache lines, which are the units in which the cache memory is managed. The access master can read and write data at high speed in cases in which the necessary data are stored in the cache memory and are reliably accessible. Such cases are called cache hits.

Conversely, a case in which the access master requests access but the data at the requested address are not stored in the cache memory is called a cache miss. In such cases, the data to which access is requested must be transferred from main memory to the cache memory. This results in lower speed, due to program waiting time, and in increased power consumption. It would therefore be desirable to boost the probability that the data required by the access master can be reliably accessed (boost the cache hit ratio) by prereading the data from the main memory and transferring the data to the cache memory.

As a prereading method, Patent Reference 1 describes an information processor that stores instructions from the access master in a buffer, prereads data on the basis of a past interrupt instruction history, and stores the data in the cache memory. As a result, when the access master re-executes an interrupt instruction that it had executed before, a cache hit occurs, the branch to the interrupt routine can be made quickly, and the return from the interrupt routine or subroutine can also be carried out quickly.

### PRIOR ART REFERENCES

### Patent Reference

### Patent Reference 1: Japanese Patent No. 4739380

### SUMMARY OF THE INVENTION

### Problem to be Solved by the Invention

The only data that can be preread by the information processor described in Patent Reference 1, however, are interrupt instructions with a history of previous execution. Therefore, the access master cannot preread interrupt instructions that have not been executed yet, and data at branch destinations differing from past execution. Cache misses therefore occur, causing problems.

An object of the present invention is to enable cache hits to be reliably obtained even for instructions and data that the access master has not accessed.

### Means of Solving the Problem

A cache memory controller according to an aspect of the invention is connected to a main memory having an instruction area storing a first program and a data area storing data used by a specific instruction included in the first program, and to an access master for executing instructions included in the first program. The cache memory controller includes a cache memory for storing a portion of the data in the main memory, and a data processing unit that, prior to execution of the specific instruction by the access master, and in accordance with transfer scheduling information including the starting address of the specific instruction, calculates an access interval on a basis of a number of instruction steps remaining from an address of the instruction currently being executed by the access master to the starting address of the specific instruction, and transfers data used by the specific instruction from the main memory to the cache memory at this access interval.

A cache memory control method according to another aspect of the invention uses a cache memory to provide an access master that executes instructions included in a first program with data used by a specific instruction in the first program from a main memory having an instruction area for storing the first program and a data area for storing the data used by the specific instruction. The cache memory control method includes: a transfer step for, prior to execution of the specific instruction by the access master, and in accordance with transfer scheduling information including a starting address of the specific instruction, calculating an access interval on a basis of a number of instruction steps remaining from an address of an instruction currently being executed by the access master to the starting address of the specific instruction, and transferring the data used by the specific instruction from the main memory to the cache memory at this access interval; and a providing step for providing the data used by the specific instruction from the cache memory to the access master when the access master executes the specific instruction.

### Effect of the Invention

These aspects of the present invention enable cache hits to be reliably obtained even for instructions and data that the access master has not accessed.

### BRIEF DESCRIPTION OF THE DRAWINGS

FIG. 1 is a block diagram schematically showing the configuration of a cache memory controller according to a first embodiment.

FIG. 2 is a schematic diagram showing a transfer scheduling function for operating the cache memory controller according to the first embodiment.

FIG. 3 is a schematic diagram showing an exemplary application of the transfer scheduling function to a second program in the first embodiment.

FIG. 4 is a flowchart illustrating the process of compiling the second program into the first program in the first embodiment.

FIG. 5 is a schematic diagram showing the relation between compilation input and output in the first embodiment.

FIG. 6 is a schematic diagram showing an exemplary first program generated when the compiler compiles the second program in the first embodiment.

FIG. 7 is a schematic diagram showing an example of the disposition of the first program in main memory in the first embodiment.

FIG. 8 is a flowchart illustrating the process performed by the process switching unit in the data processing unit in the first embodiment.

FIG. 9 is a schematic diagram showing an exemplary timing diagram of the process performed by the process switching unit in the first embodiment.

FIG. 10 is a flowchart illustrating the process performed by the request processing unit in the data processing unit in the first embodiment.

FIG. 11 is a flowchart illustrating the process performed by the schedule processing unit in the data processing unit in the first embodiment.

FIGS. 12(a) to 12(c) are schematic diagrams illustrating the progress of a data transfer by the schedule processing unit in the first embodiment.

FIG. 13 is a schematic diagram showing an exemplary timing diagram of the process performed by the schedule processing unit in the first embodiment.

FIG. 14 is a flowchart illustrating the process performed by the release processing unit in the data processing unit in the first embodiment.

FIG. 15 is a schematic diagram showing an exemplary variation of the second program in the first embodiment.

FIG. 16 is a block diagram schematically showing the configuration of a cache memory controller according to a second embodiment.

FIG. 17 is a table stored by the schedule processing unit in the second embodiment.

FIG. 18 is a schematic diagram showing exemplary access management information in the second embodiment.

FIG. 19 is a flowchart illustrating the process performed by the priority determination unit in the data processing unit in the second embodiment.

FIG. 20 is a diagram showing a first example of two items of transfer scheduling information that are included in the first program and for which priority is determined by the priority determination unit in the data processing unit in the second embodiment.

FIG. 21 is a diagram showing a second example of two items of transfer scheduling information that are included in the first program and for which priority is determined by the priority determination unit in the data processing unit in the second embodiment.

FIG. 22 is a diagram showing a third example of two items of transfer scheduling information that are included in the first program and for which priority is determined by the priority determination unit in the data processing unit in the second embodiment.

FIG. 23 is a diagram showing a fourth example of two items of transfer scheduling information determined by the priority determination unit in the data processing unit, included in the first program in the second embodiment.

FIG. 24 is a diagram showing a fifth example of two items of transfer scheduling information that are included in the first program and for which priority is determined by the priority determination unit in the data processing unit in the second embodiment.

FIG. 25 is a schematic diagram showing an exemplary timing diagram of the process performed by the priority determination unit in the data processing unit in the second embodiment.

FIG. 26 is a flowchart illustrating the process performed by the schedule processing unit in the data processing unit in the second embodiment.

FIG. 27 is a schematic diagram showing an exemplary timing diagram of the process performed by the priority determination unit in the data processing unit in the second embodiment.

FIG. 28 is a block diagram schematically showing an exemplary variation of the cache memory controller according to the second embodiment.

FIG. 29 is a schematic diagram showing a variation of the transfer scheduling management information in the second embodiment.

FIG. 30 shows exemplary current address management information in the second embodiment.

### MODE FOR CARRYING OUT THE INVENTION

### First Embodiment

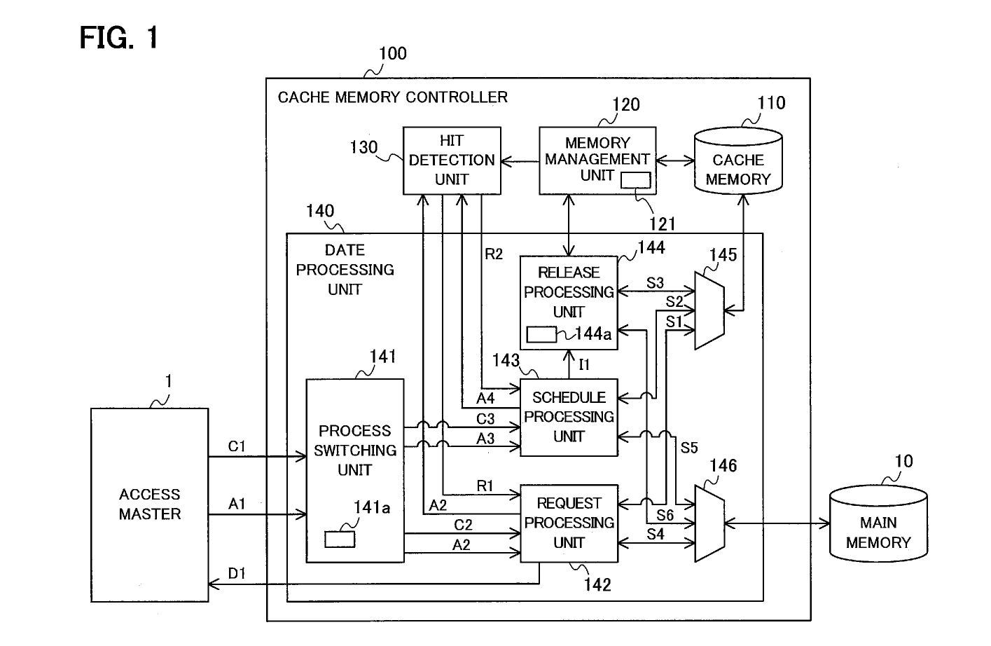

FIG. 1 is a block diagram schematically showing the configuration of the cache memory controller 100 according to the first embodiment. The cache memory controller 100 includes a cache memory 110, a memory management unit 120, a hit detection unit 130, and a data processing unit 140.

The connection relationships among an access master 1, the cache memory controller 100, and a main memory 10 are shown in FIG. 1 in a simplified form. On the basis of an instruction command C1 from the access master 1, the cache memory controller 100 accesses data stored in the cache memory 110, which will be described later, or the main memory 10. Here, the instruction command C1 is a request from the access master 1 for access to an address on the main memory 10. If, for example, the instruction command C1 is a read request, the instruction command C1 and an instruction address A1 that indicates the address on the main memory 10 are input from the access master 1 to the cache memory controller 100. The cache memory controller 100 then outputs read data D1 corresponding to the instruction command C1 and instruction address A1 to the access master 1.

FIG. 1 shows a cache memory controller 100 configured with a single access master 1, but a plurality of access masters 1 may share the cache memory controller 100. The access master 1 is configured as a control unit such as a CPU, for example, that executes instructions according to processes in a computer program (first program) stored in the main memory 10.

The main memory 10 includes an instruction area and a data area. The instruction area stores instructions to be executed by the access master 1; the data area stores data used in processing by the access master 1. In this embodiment, for example, the instruction area stores the first program and the data area stores data used by the instructions included in the first program.

The cache memory 110 stores a portion of the data stored in the main memory 10. The cache memory 110 is configured with semiconductor memory such as SRAM (Static Random Access Memory), for example, data in which can be accessed more quickly than data in the main memory 10. The cache memory 110 is divided into, for example, 64-byte units called cache lines. A cache line stores 64 consecutive bytes of data in the main memory 10.

The memory management unit 120 manages the cache memory 110. The memory management unit 120 includes, for example, a tag memory 121 as a management information storage unit and uses the tag memory 121 to manage the cache memory 110.

As management information, the tag memory 121 stores address information Ta, a status flag Fs, and an access flag Fa: the address information Ta is the address of the data stored in each cache line of the cache memory 110 in the main memory 10; the status flag Fs is status identification information indicating whether or not data are present in each cache line; the access flag Fa is access identification information indicating whether or not the access master 1 has accessed each cache line.

The status flag Fs indicates, for each cache line, ‘valid’ if data are present in the cache line in the cache memory 110, and ‘invalid’ if data are not present.

The access flag Fa indicates, for each cache line, ‘valid’ if the access master 1 has accessed the cache line, and ‘invalid’ if the access master 1 has not accessed the cache line. On the basis of, for example, the LRU (Least Recently Used) method, which checks for access during a prescribed residence time, the memory management unit 120 resets the access flag Fa at prescribed timings: for example, when a timer (not shown) has measured a prescribed elapse of time. This enables the memory management unit 120 to determine which cache lines have not recently been accessed.

The hit detection unit 130 determines whether the data at the address on the main memory 10 to which access is requested are stored in the cache memory 110. The hit detection unit 130 then provides the data processing unit 140 with a hit detection result indicating a cache hit if the data are stored in the cache memory 110 or a cache miss if the data are not stored in the cache memory 110. The hit detection unit 130 determines whether or not the data are stored in the cache memory 110 by referring to the address information Ta in the cache lines for which the status flag Fs in the tag memory 121 indicates ‘valid’. Existence in the memory management unit 120 of address information Ta matching the address to which access has been requested results in a cache hit; non-existence of such address information Ta results in a cache miss.

The data processing unit 140 transfers data stored in the main memory 10 to the cache memory 110. In this embodiment, for example, according to transfer scheduling information including the address of data used by a specific instruction included in the first program, before the access master 1 executes the specific instruction, the data processing unit 140 transfers the data used by the specific instruction from the main memory 10 to the cache memory 110. The data processing unit 140 also reads data from the cache memory 110 or main memory 10 in response to requests from the access master 1. Furthermore, the data processing unit 140 writes data into the cache memory 110 or main memory 10 in response to requests from the access master 1. The data processing unit 140 includes a process switching unit 141, a request processing unit 142, a schedule processing unit 143, a release processing unit 144, a cache memory access arbitration unit 145, and a main memory access arbitration unit 146.

The process switching unit 141 analyzes an instruction command C1 from the access master 1 and switches the data output destination between the request processing unit 142 and schedule processing unit 143. For example, if the instruction command C1 indicates read or write, the process switching unit 141 gives the instruction command C1 as a request command C2 and the instruction address A1 as a request address A2 to the request processing unit 142. If the instruction command C1 indicates read, the process switching unit 141 also stores the instruction address A1 as a current address A3 in a memory (in-progress storage unit) 141a. Here, the current address A3 indicates the address currently under execution by the access master 1. Conversely, if the instruction command C1 indicates transfer scheduling information representing the scheduling of a data transfer, the process switching unit 141 gives the instruction command C1 as a transfer scheduling command C3 to the schedule processing unit 143, together with the current address A3 stored in the memory 141a.

The request processing unit 142 reads or writes data on the cache memory 110 or main memory 10 according to the request command C2 and request address A2 input from the process switching unit 141 and the hit detection result R1 input from the hit detection unit 130. When the request processing unit 142 receives a request address A2 from the process switching unit 141, for example, it provides the request address A2 to the hit detection unit 130. In response, the request processing unit 142 then obtains a hit detection result R1 for the request address A2 from the hit detection unit 130. If the request command C2 input from the process switching unit 141 indicates a read, the request processing unit 142 outputs read data D1 read from the cache memory 110 or main memory 10 to the access master 1.

Transfers of information between the request processing unit 142 and cache memory access arbitration unit 145 are carried out via a signal S1. Transfers of information between the request processing unit 142 and main memory access arbitration unit 146 are carried out via a signal S4.

The schedule processing unit 143 transfers data from the main memory 10 to the cache memory 110 according to the current address A3 and transfer scheduling command C3 input from the process switching unit 141 and the hit detection result R2 input from the hit detection unit 130. For example, on receipt of a transfer scheduling command C3 from the process switching unit 141, the schedule processing unit 143 identifies the address (transfer scheduling address) at which the data to be transferred are stored in the main memory 10, and provides the identified address A4 to the hit detection unit 130. In response, the schedule processing unit 143 then obtains the hit detection result R2 for the address A4 from the hit detection unit 130. If the hit detection result R2 is a cache miss, the schedule processing unit 143 transfers the data at that address from the main memory 10 to the cache memory 110. When the schedule processing unit 143 starts a transfer according to a transfer scheduling command C3, it provides the release processing unit 144 with scheduled area information I1 indicating the storage destination cache line.

Transfers of information between the schedule processing unit 143 and cache memory access arbitration unit 145 are carried out via a signal S2. Transfers of information between the schedule processing unit 143 and main memory access arbitration unit 146 are carried out via a signal S5.

The release processing unit 144 selects a cache line to release when it determines through the memory management unit 120 that the cache memory 110 is running short of free space. The release processing unit 144 monitors the status flags Fs in the tag memory 121 of the memory management unit 120, for example, and determines that the cache memory 110 is running short of free space when the number of status flags Fs indicating ‘invalid’ is equal to or less than a prescribed number (threshold value) T, for example. At this point, the release processing unit 144 selects a cache line to release on the basis of the access flags Fa in the tag memory 121 and the scheduled area information I1 from the schedule processing unit 143. When the release processing unit 144 selects a cache line to release, it provides the cache memory access arbitration unit 145 with release information indicating that the data in the selected cache line are to be written back to the main memory 10.

In selecting a cache line to release, the release processing unit 144 refers to the scheduled area information I1 from the schedule processing unit 143. For example, on the basis of the scheduled area information I1, the release processing unit 144 monitors the access flags Fa of the cache lines in which data have been stored by the schedule processing unit 143 and records whether or not their access flags Fa have been set in ‘valid’ by the access master 1 accessing the data stored in those cache lines one or more times, recording this information as scheduled area access flags Fra in a memory (access history information storage area) 144a. If the access master 1 has not accessed the data in a cache line even once, the release processing unit 144 does not release that cache line. When a cache line is released, the release processing unit 144 resets its scheduled area access flag Fra.

Transfers of information between the release processing unit 144 and cache memory access arbitration unit 145 are carried out via a signal S3. Transfers of information between the release processing unit 144 and main memory access arbitration unit 146 are carried out via a signal S6.

The cache memory access arbitration unit 145 arbitrates the order of access to the cache memory 110 according to the signals S1 to S3 input, based on a predetermined priority order, from the request processing unit 142, schedule processing unit 143, and release processing unit 144. The cache memory access arbitration unit 145 then provides signals S1 to S3 to the cache memory 110 in the arbitrated order. The priority order may be, for example, request processing unit 142, release processing unit 144, and schedule processing unit 143, in order from high to low.

Accordingly, if signals are input to the cache memory access arbitration unit 145 simultaneously from two or more of the request processing unit 142, schedule processing unit 143, and release processing unit 144, access to the cache memory 110 based on signals with lower priority is halted so that access to the cache memory 110 based on a higher priority signal can be carried out. Among the simultaneously input signals, access based on a lower priority signal starts when access based on higher priority signals ends.

The main memory access arbitration unit 146 arbitrates the order of access to the main memory 10 according to the input signals S4 to S6 input, based on a predetermined priority order, from the request processing unit 142, schedule processing unit 143, and release processing unit 144. The priority order may be, for example, request processing unit 142, release processing unit 144, schedule processing unit 143, in order from high to low.

Accordingly, if signals are input to the main memory access arbitration unit 146 simultaneously from two or more of the request processing unit 142, schedule processing unit 143, and release processing unit 144, access to the main memory 10 based on signals with lower priority is halted so that access to the main memory 10 based on a higher priority signal can be carried out. Among the simultaneously input signals, access based on a lower priority signal starts when access based on higher priority signals ends.

In this process, when access to data at the same address is simultaneously requested from the request processing unit 142 and schedule processing unit 143 and the data at that address are not stored on the cache memory 110, the main memory access arbitration unit 146 treats only the access request from the request processing unit 142 as valid. The main memory access arbitration unit 146 outputs, to the schedule processing unit 143, a scheduled transfer completion flag Ftf indicating that the transfer of the data at that address has been completed.

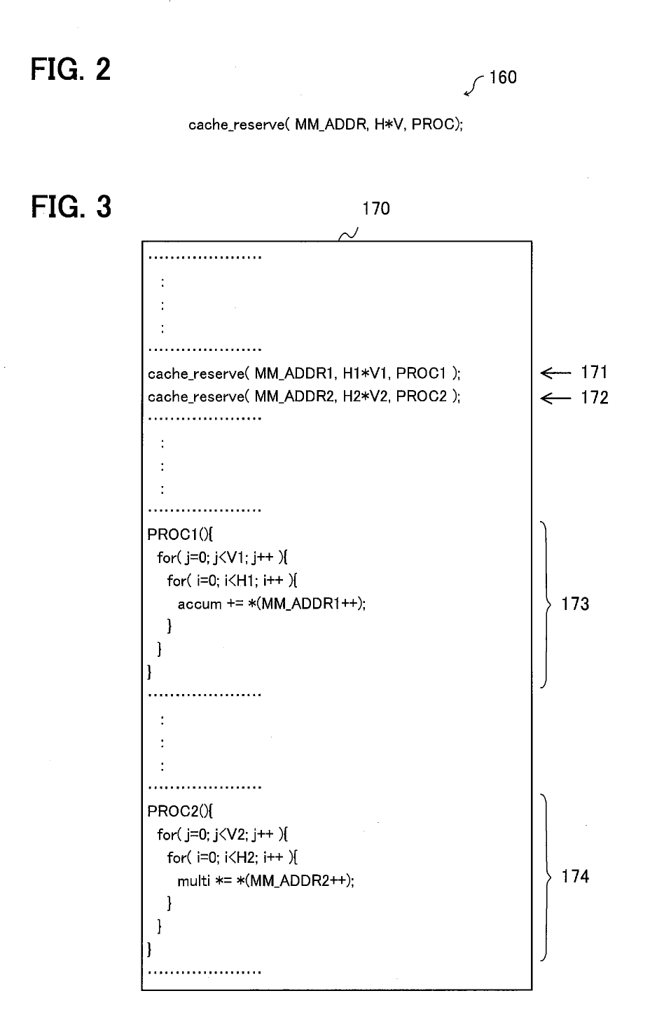

FIG. 2 is a schematic drawing showing a transfer scheduling function 160 for operating the cache memory controller 100. The transfer scheduling function 160 is a code representing a transfer scheduling instruction for transferring specific data from the main memory 10 to the cache memory 110. As shown in FIG. 2, the transfer scheduling function 160 defines the starting address MM_ADDR of a continuous area that will be referred to by the access master 1 after this function is executed, the size H*V of the continuous area, and the starting address PROC of a group of instructions constituting a function that refers to the continuous area. The continuous area is a portion of the instruction area or data area on the main memory 10 with consecutive addresses. In this embodiment, the starting address MM_ADDR, size H*V, and starting address PROC constitute transfer scheduling information.

The first program is executed by the access master 1, so it is coded in a format that the access master 1 can execute: for example, in an assembly language or the like. Conversely, the transfer scheduling function 160 shown in FIG. 2 is included in a second program coded in a format that the access master 1 cannot execute: for example, in C language or another high level language. The first program is generated by compilation of the second program.

FIG. 3 is a schematic drawing showing an exemplary application of the transfer scheduling function 160 shown in FIG. 2 to the second program. The second program 170 shown in FIG. 3 includes a function 173 composed of instructions by which the access master 1 refers to data disposed in a continuous area on the main memory 10 and a function 174 composed of instructions by which the access master 1 refers to data disposed in another such continuous area. In program 170, a transfer scheduling function 171 and a transfer scheduling function 172 are processed before functions 173 and 174 are executed.

The second program is coded so that the transfer scheduling function 160 is processed before the access master 1 executes the process that refers to the data in the continuous area; therefor it is possible to inserted into the first program, in a format capable of execution by the access master 1, a command for transferring the data in the continuous area, for which an assured cache hit is desired, from the main memory 10 to the cache memory 110.

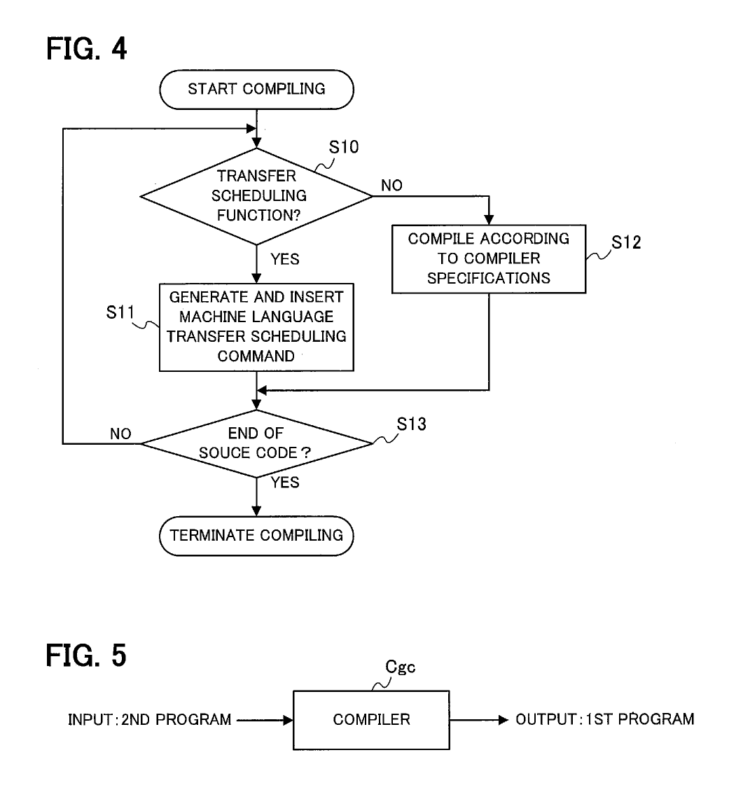

FIG. 4 is a flowchart illustrating the process of compiling (converting) the second program 170 shown in FIG. 3 into the first program. The flow shown in FIG. 4 is executed by input of the second program to a compiler Cgc as shown in FIG. 5. The compiler Cgc is a program conversion unit equipped with a function for compiling the transfer scheduling function 160 shown in FIG. 2 according to commonly used specifications. The second program 170 is assumed to be stored in a storage unit not shown in the drawings.

When compilation starts, the compiler Cgc decides whether or not the source code under compilation in the second program is a transfer scheduling function 160 as shown in FIG. 2 (step S10). If the source code is a transfer scheduling function 160 (Yes in S10), the process proceeds to step S11; if the source code is not a transfer scheduling function 160 (No in S10), the process proceeds to step S12.

In step S11, the compiler Cgc compiles the source code into a command suitable for the first program. In step S12, the compiler Cgc compiles the source code according to commonly used specifications.

The compiler Cgc then decides whether or not the source code under compilation is at the end of the second program (S13). If the source code is not at the end (No in S13), the compiler Cgc updates the code under compilation to the next source code and returns to step S10. If the source code is at the end (Yes in S13), the compiler Cgc terminates the processing flow.

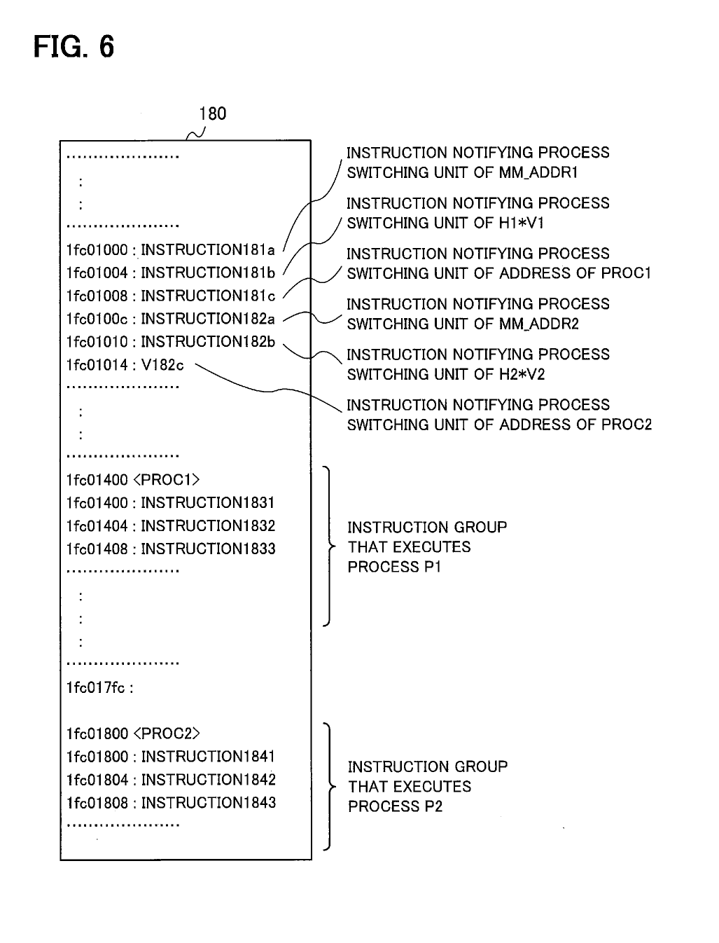

FIG. 6 is a schematic diagram showing an exemplary first program generated when the compiler Cgc compiles the second program 170 shown in FIG. 3. In the first program 180 shown in FIG. 6, addresses are given in the left column and instruction words are given in hexadecimal notation in the right column. The instruction format depends on the compiler Cgc, so the instruction word format will not be described here, but the operation indicated by each instruction will be described.

Instructions 181a to 181c shown in FIG. 6 are transfer scheduling instructions generated from the transfer scheduling function 171 shown in FIG. 3. Instruction 181a is an instruction for notifying the process switching unit 141 of the starting address MM_ADDR1 of the continuous area described in the transfer scheduling function 171 shown in FIG. 3. Instruction 181b is an instruction for notifying the process switching unit 141 of the size H1*V1 of the continuous area described in the transfer scheduling area 171 shown in FIG. 3. Instruction 181c is an instruction for notifying the process switching unit 141 of the starting address PROC1 described in the transfer scheduling function 171 shown in FIG. 3. Instructions 182a to 182c are transfer scheduling instructions generated from the transfer scheduling function 172 in FIG. 3. Instruction 182a is an instruction for notifying the process switching unit 141 of the starting address MM_ADDR2 of the continuous area described in the transfer scheduling function 172 shown in FIG. 3. Instruction 182b is an instruction for notifying the process switching unit 141 of the size H2*V2 of the continuous area described in the transfer scheduling function 172 shown in FIG. 3. Instruction 182c is an instruction for notifying the process switching unit 141 of the starting address PROC2 described in the transfer scheduling function 172 shown in FIG. 3.

As shown in FIG. 6, in the first program 180, the transfer scheduling instructions 181a to 181c and 182a to 182c are coded ahead of the instruction groups 1831, 1832, 1833, . . . , 1841, 1842, 1843, . . . for executing processes P1 and P2, which are carried out with use of data in the main memory 10, so the access master 1 executes transfer scheduling instructions 181a to 181c and 182a to 182c before executing these instruction groups. This enables the access master 1 to send the process switching unit 141 instruction commands C1 indicating transfer scheduling information according to transfer scheduling instructions 181a to 181c and 182a to 182c before executing these instruction groups. This causes the data used by these instruction groups to be transferred from the main memory 10 to the cache memory 110 before the access master 1 executes these instruction groups.

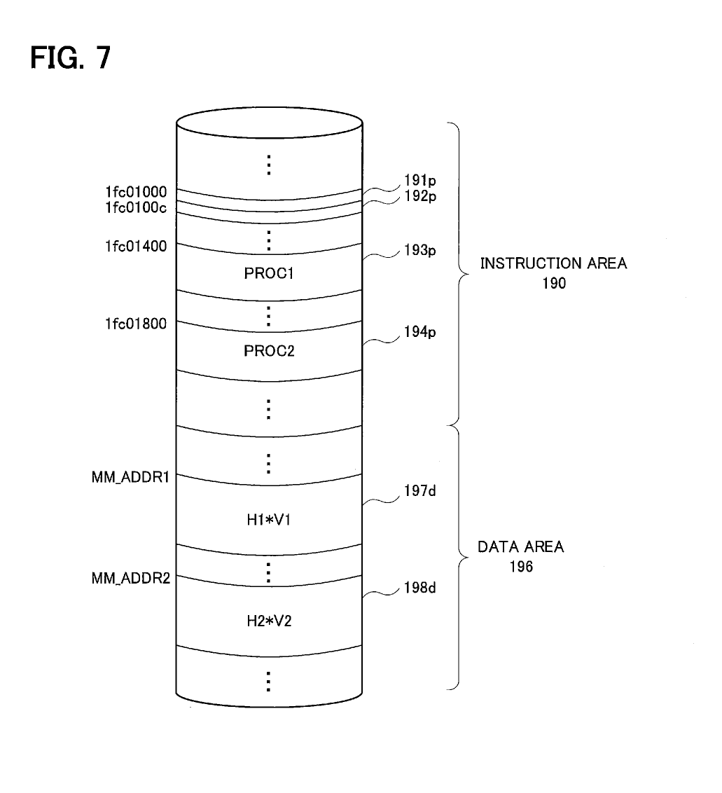

FIG. 7 is a schematic diagram showing an example of the disposition of the first program 180 shown in FIG. 6 in the main memory 10. In FIG. 7, the first program 180 shown in FIG. 6 is stored in the instruction area 190 on the main memory 10. In particular, the instructions 181a to 181c used to compile the transfer scheduling function 171 shown in FIG. 3 are disposed in an area 191p; the instructions 182a to 182c used to compile transfer scheduling function 172 are disposed in an area 192p.

The schedule processing unit 143 is notified of the starting address of the continuous area 197d referred to by function 173 in FIG. 3 when the access master 1 executes instruction 181a (see FIG. 6) in area 191p. Next, the access master 1 executes instruction 181b (see FIG. 6) in area 191p, whereby the schedule processing unit 143 is notified of the size of the continuous area 197d. Then the access master 1 executes instruction 181c (see FIG. 6) in area 191p, whereby the schedule processing unit 143 is notified of the starting address of the area 193p in which the commands corresponding to function 173 shown in FIG. 3 are stored.

Similarly, the schedule processing unit 143 is notified of the starting address and size of the continuous area 198d referred to by function 174 shown in FIG. 3 and the starting address of the area 194p in which the commands corresponding to function 174 shown in FIG. 3 are stored when the access master 1 executes instructions 182a to 182c (see FIG. 6) in area 192p.

Next, the processing flow in the cache memory controller 100 will be described by use of a flowchart.

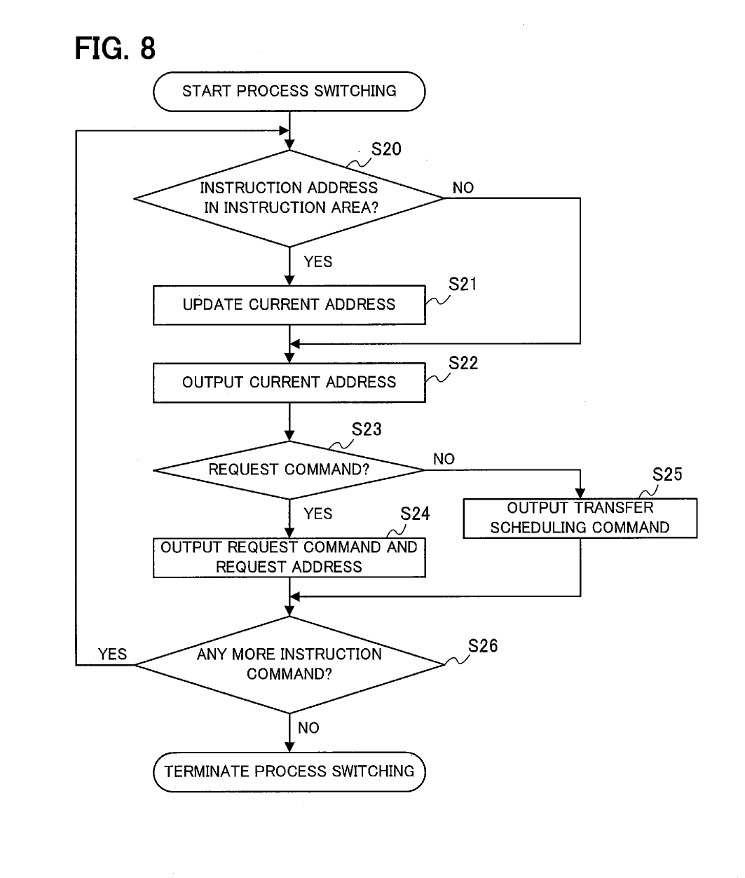

FIG. 8 is a flowchart illustrating the process executed by the process switching unit 141 in the data processing unit 140. The process switching unit 141 starts this process when an instruction command C1 and an instruction address A1 are input from the access master 1.

First, the process switching unit 141 decides whether or not the input instruction A1 is an address included in the instruction area 190 shown in FIG. 7 (S20). If the instruction address A1 is an address in the instruction area 190 (Yes in S20), the process proceeds to step S21; if the instruction address A1 is not an address in the instruction area 190 (No in S20), the process proceeds to step S22.

In step S21, the process switching unit 141 stores the input instruction address A1 as a current address A3 in memory 141a. If a current address A3 has already been stored, the process switching unit 141 updates its value. Conversely, if the instruction address A1 is not an address in the instruction area 190, the current address A3 is not updated.

In step S22, the process switching unit 141 provides the schedule processing unit 143 with the current address A3 stored in memory 141a.

Next, the process switching unit 141 decides whether the instruction command C1 input from the access master 1 is a read or write (S23). If the instruction command is a read or write (Yes in S23), the process proceeds to step S24; if the instruction command C1 is neither a read nor a write (No in step S23), the process proceeds to step S25.

In step S24, the process switching unit 141 provides the input instruction command C1 and instruction address A1 as a request command C2 and a request address A2, respectively, to the request processing unit 142. Alternatively, in step S25 the process switching unit 141 provides the instruction command C1 as a transfer scheduling command C3 to the schedule processing unit 143. Instructions 181a to 181c and instructions 182a to 182c shown in FIG. 6 are exemplary transfer scheduling commands C3.

Next, the process switching unit 141 decides whether or not an instruction command C1 from the access master 1 (an instruction command C1 that has not been processed yet) is present in the data processing unit 140 (S26). If an instruction command C1 that has not been processed yet is present (Yes in S26), the process returns to step S20; if an instruction command C1 that has not been processed yet is not present (No in S26), the process switching unit 141 terminates the processing flow.

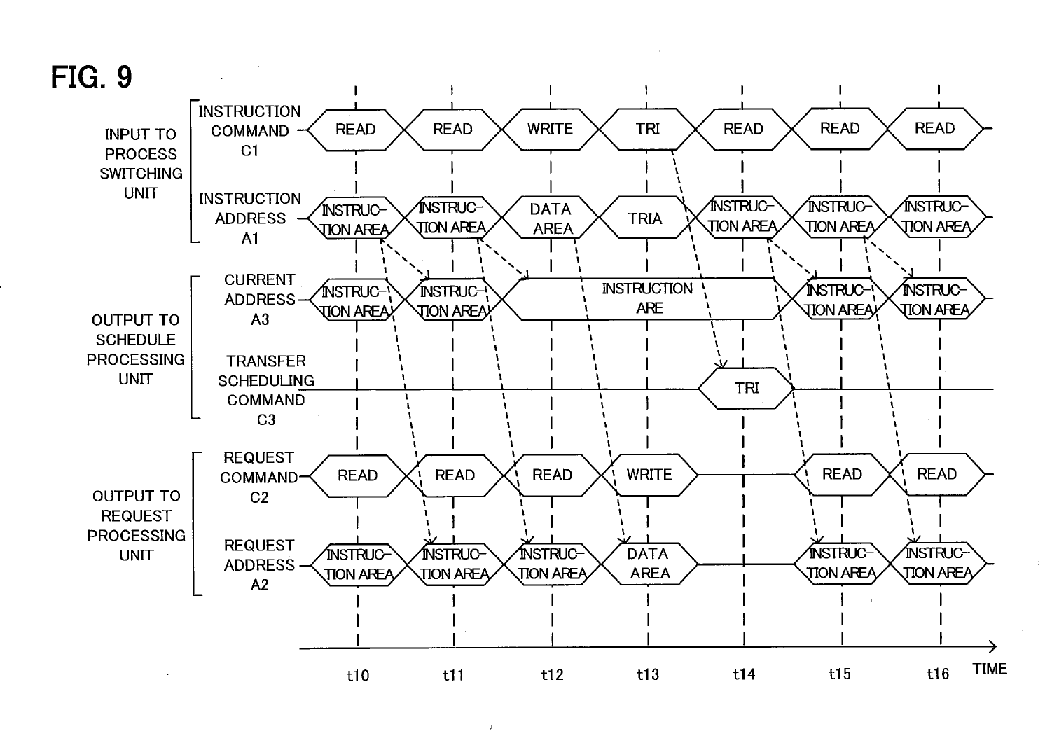

FIG. 9 schematically shows an exemplary timing diagram of the processing in the process switching unit 141. FIG. 9 shows timings at which instruction commands C1 are input to the process switching unit 141 from the access master 1, timings at which data are output to the request processing unit 142, and timings at which data are output to the schedule processing unit 143.

At time t10 the process switching unit 141 receives an instruction command C1 indicating a read request and an instruction address A1 indicating a program area as inputs from the access master 1, and at time t11 it outputs them to the request processing unit 142 as, respectively, a request command C2 and a request address A2. The process switching unit 141 also updates the value of the current address A3 to a value indicating instruction address A2 and provides it to the schedule processing unit 143.

Next, the process switching unit 141 receives an instruction command C1 indicating a write request and an instruction address A1 indicating a data area as inputs from the access master 1 at time t12, and at time t13 it provides them to the request processing unit 142 as, respectively, a request command C2 and a request address A2. Since the instruction address A1 indicates a data area, the process switching unit 141 provides the current address A3 stored in memory 141a to the schedule processing unit 143 without updating the value of the current address A3.

At time t13, the process switching unit 141 receives an instruction command C1 (TRI) indicating data transfer scheduling and an instruction address A1 (TRIA) indicating transfer scheduling as inputs from the access master 1; it does not output them to the request processing unit 142, but at time t14, it provides the current address A3 stored in memory 141a to the schedule processing unit 143 and provides the instruction command C1 to the schedule processing unit 143 as a transfer scheduling command C3.

At time t14, the process switching unit 141 receives an instruction command C1 indicating a read request and an instruction address A1 indicating a program area as inputs from the access master 1, and at time t15 it provides them to the request processing unit 142 as, respectively, a request command C2 and a request address A2. The process switching unit 141 also updates the value of the current address A3 to the value indicated by the instruction address A1 and provides it to the schedule processing unit 143.

As described above, the process switching unit 141 switches output destinations between the request processing unit 142 and schedule processing unit 143 according to the instruction command C1 and instruction address A1 input from the access master 1.

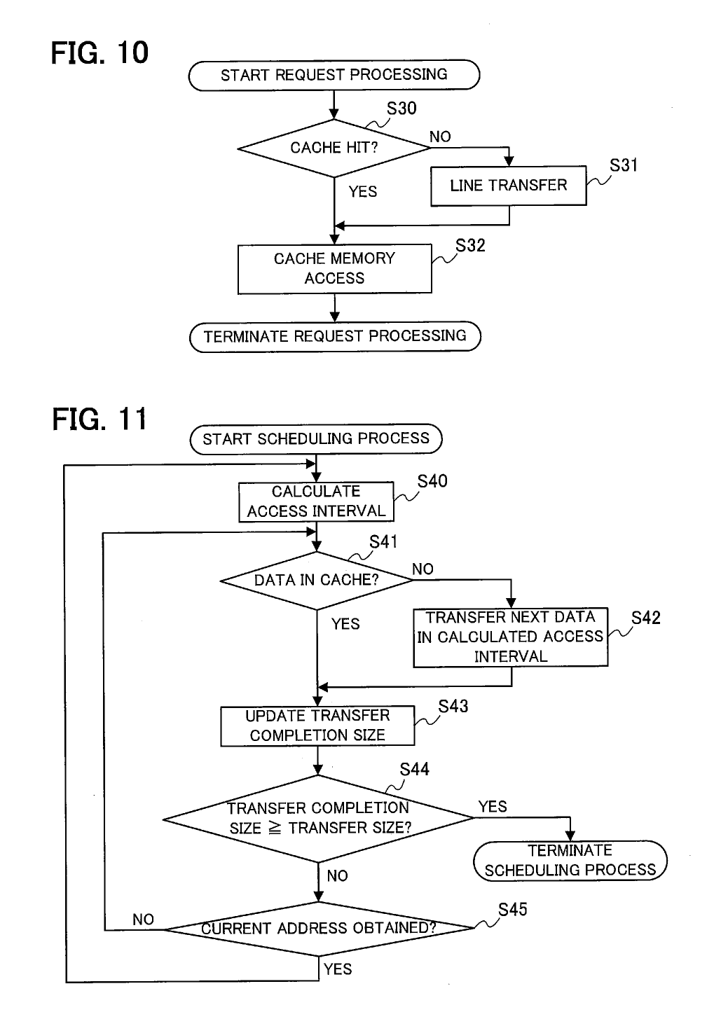

FIG. 10 is a flowchart illustrating the process performed by the request processing unit 142 in the data processing unit 140. This process starts when the request processing unit 142 receives a request command C2 and request address A2 as inputs from the process switching unit 141 and a hit detection result R1 indicating a cache hit or a cache miss as an input from the hit detection unit 130.

First, the request processing unit 142 decides from the hit detection result R1 from the hit detection unit 130 whether or not the data requested by the request command C2 are present in the cache memory 110 (S30). If the data requested by the request command C2 are not present in the cache memory 110 (No in S30), in other words, if the hit result R1 indicates a cache miss, the process proceeds to step S31. Conversely, if the data requested by the request command C2 are present in the cache memory 110 (Yes in S30), in other words, if the hit result R1 indicates a cache hit, the process proceeds to step S32.

In step S31, in order to transfer data from the main memory 10 to the cache memory 110, the request processing unit 142 gives a data transfer instruction to the main memory access arbitration unit 146. This instruction includes the request address A2. The main memory access arbitration unit 146 then performs a process that transfers the data stored at the address indicated by the request address A2 from the main memory 10 to the cache memory 110. For example, the main memory access arbitration unit 146 reads the data stored at the address indicated by the request address A2 from the main memory 10 and sends the data to the request processing unit 142. The request processing unit 142 provides the received data to the cache memory access arbitration unit 145 to have the data written into the cache memory 110. When the data are written into the cache memory 110, the memory management unit 120 stores the address of the written data in the tag memory 121 as address information Ta and updates the corresponding status flag Fs to indicate the presence of data.

In step S32, the request processing unit 142 accesses the cache memory 110. If the request command C2 indicates a write instruction, in order to write the data indicated by the request command C2 in a cache line, the request processing unit 142 provides the request command C2 and request address A2 to the cache memory access arbitration unit 145. Conversely, if the request command C2 is a read instruction, in order to read the data indicated by the request command C2 from a cache line, the request processing unit 142 provides the request address A2 of the data to be read to the cache memory access arbitration unit 145. The data obtained in this way are provided to the access master 1 as read data D1. When the cache memory 110 is accessed, the memory management unit 120 updates the access flag Fa stored in the tag memory 121 to indicate that an access has been performed.

When the request command C2 indicates a read request and the hit detection result R1 indicates a cache miss, the request processing unit 142 may transfer, to the cache memory 110 via the cache memory access arbitration unit 145, the data read from the main memory 10 via the main memory access arbitration unit 146 and output the data as read data to the access master 1. In this case, the process in step S32 in FIG. 10 is not performed. The memory management unit 120, however, updates the access flag Fa stored in the tag memory 121 to indicate that an access has been made.

FIG. 11 is a flowchart illustrating the process performed by the schedule processing unit 143 in the data processing unit 140. This process starts when the schedule processing unit 143 receives, from the process switching unit 141, the current address A3, the starting address MM_ADDR of a continuous area in which data to be transferred are stored, the size H*V of the continuous area in which the data to be transferred are stored, and the starting address PROC of the instruction group that refers to the continuous area in which the data to be transferred are stored, and receives a hit detection result R2 indicating a cache hit or a cache miss from the hit detection unit 130.

First, the schedule processing unit 143 calculates an interval of access (referred to below as an access interval Da) to the main memory 10 (S40). The number of instruction steps Ds from the current address A3 to the starting address PROC of the instruction group that refers to the continuous area in which the data to be transferred are stored is used in the calculation of the access interval Da. The number of instruction steps Ds can be calculated, as shown in the following expression (1), as the difference from the current address A3, which is the instruction address when the scheduling process starts, to the starting address PROC of the instruction group that refers to the continuous area in which the data to be transferred are stored.

Ds=(starting address PROC of instruction group)−(current address A3) (1)

Then, as shown in the following equation (2), the schedule processing unit 143 can calculate the number of instruction steps Dspu required per transfer of unit size by dividing the number of instruction steps Ds by the size Rs of the remaining continuous area for which the transfer has not been completed yet, which is some part of the size H*V, input from the process switching unit 141, of the continuous area in which the data to be transferred are stored. The schedule processing unit 143 uses the number of instruction steps Dspu required per transfer of unit size as the access interval Da.

Dspu=(number of instruction steps Ds)÷(size Rs of remaining continuous area) (2)

Next, the schedule processing unit 143 decides whether or not, among the data to be transferred in the continuous area, the data to be transferred next are present in the cache memory 110 (S41). In this case, the data to be transferred next are data of unit transfer length among the data to be transferred in the continuous area. If the data to be transferred next are not present in the cache memory 110 (No in S41), in other words, if the hit detection result R2 for the data to be transferred next is a cache miss, the data must be transferred from the main memory 10 to the cache memory 110, so the schedule processing unit 143 proceeds to step S42. Conversely, if the data to be transferred next are present in the cache memory 110 (Yes in S41), in other words, if the hit detection result R2 for the data to be transferred next is a cache hit, then the data need not be transferred from the main memory 10 to the cache memory 110, so the schedule processing unit 143 does not transfer the data and proceeds to step S43.

In step S42, the schedule processing unit 143 gives the main memory access arbitration unit 146 an instruction to transfer data from the main memory 10 to the cache memory 110 in the access interval Da calculated in step S40. If the access interval Da is ‘8’, for example, a unit transfer length of data must be transferred before the current address A3 advances eight steps. For this reason, the schedule processing unit 143 gives a transfer instruction to the main memory access arbitration unit 146 at one of the eight steps, such as the first of the eight steps. When it receives this transfer instruction, the main memory access arbitration unit 146 reads the data to be transferred from the main memory 10 and gives the data to the schedule processing unit 143. The schedule processing unit 143 provides the given data to the cache memory access arbitration unit 145 to have the data written into the cache memory 110. When the data are written into the cache memory 110, the memory management unit 120 stores the address of the written data as address information in the tag memory 121 and updates the corresponding status flag Fs so as to indicate the presence of data.

Next, the schedule processing unit 143 updates the transfer completion size, which indicates the total size of the data that have already been transferred (S43).

Next, the schedule processing unit 143 decides whether or not the transfer completion size is equal to or greater than the size H*V of the continuous area in which the data to be transferred are stored, which was input from the process switching unit 141 (S44). If the transfer completion size is less than the size H*V of the continuous area in which the data to be transferred are stored (No in S44), the process proceeds to step S45; if it is equal to or greater than the size H*V of the continuous area in which the data to be transferred are stored (Yes in S44), the processing flow is terminated.

In step S45, the schedule processing unit 143 decides whether or not an updated current address A3 has been obtained from the process switching unit 141. If a current address A3 has been obtained (Yes in S45), the process returns to step S40; if a current address A3 has not been obtained (No in S45), the process returns to step S41.

By transferring required data to the cache memory 110 in response to transfer scheduling commands C3 as above, the schedule processing unit 143 can reliably improve the cache hit ratio, even in areas on the main memory 10 which the access master 1 has never accessed.

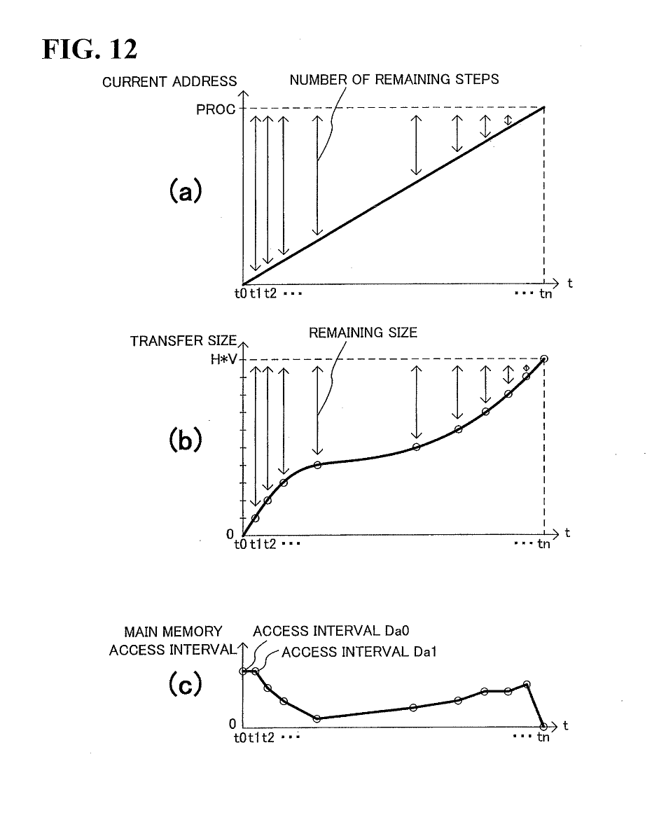

FIGS. 12(a) to 12(c) are schematic diagrams illustrating the progress of a data transfer by the schedule processing unit 143. FIG. 12(a) illustrates the changing current address A3; FIG. 12(b) illustrates the changing size of the remaining continuous area in which data to be transferred are stored; FIG. 12(c) illustrates the changing access interval Da.

As shown in FIG. 12(c), the access interval Da0 at time t0 is calculated when the transfer scheduling command C3 is input to the schedule processing unit 143.

As shown in FIG. 12(a), when the value of the current address A3 is updated at time t1, from the current size of the remaining continuous area in which data to be transferred are stored (see FIG. 12(b)) and the number of remaining steps from the current address A3 to the starting address PROC of the instruction group that refers to the continuous area (see FIG. 12(a)), the schedule processing unit 143 recalculates the access interval Da1 (see FIG. 12(c)), thereby adjusting the intervals at which the main memory 10 is accessed.

As described above, when the current address A3 is updated, the schedule processing unit 143 calculates the access interval Da again and performs transfers from the continuous area at the calculated access interval Da. The transfer process is performed in such a way that the size of the remaining continuous area in which data to be transferred are stored becomes ‘0’, that is, the transfer is completed, by the time tn when the current address reaches the starting address PROC of the instruction group that refers to the continuous area. At time tn, the current address A3 is the starting address PROC of the instruction group that refers to the continuous area, so the access interval Dan is ‘0’.

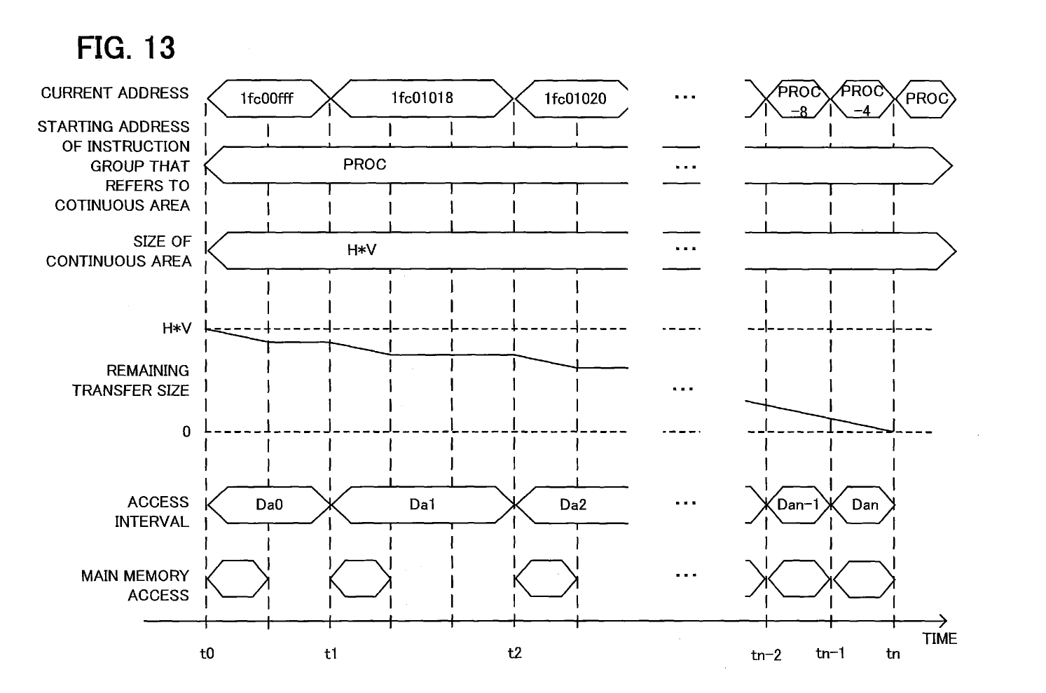

FIG. 13 schematically shows an exemplary timing diagram of the process performed by the schedule processing unit 143. FIG. 13 shows the timing at which the current address A3 and the size H*V of the continuous area in which the data to be transferred are stored are input from the process switching unit 141, timings at which the size of the remaining continuous area in which data to be transferred are stored changes, timings at which an access interval Da is calculated, and timings at which the main memory 10 is accessed.

At time t0, when a current address A3 and a transfer scheduling command C3 are input from the process switching unit 141, the schedule processing unit 143 calculates an access interval Da0. Until the current address A3 input from the process switching unit 141 is updated at time t1, the schedule processing unit 143 accesses the main memory 10 at the calculated access interval Da0.

When the current address A3 input from the process switching unit 141 is updated at time t1, the schedule processing unit 143 calculates an access interval Da1 and accesses the main memory 10 at the calculated access interval Da1 until the current address A3 is updated at time t2.

Similarly, when the current address A3 input from the process switching unit 141 is updated at time t2, the schedule processing unit 143 calculates an access interval Da2 and accesses the main memory 10 at the calculated access interval until the current address A3 is updated.

After this, the schedule processing unit 143 accesses the main memory 10 at access intervals Da calculated whenever the current address A3 input from the process switching unit 141 is updated and completes the transfer by the time the current address reaches the starting address PROC of the instruction group that refers to the continuous area, which was given by the transfer scheduling command C3.

By referring to the current address A3, adjusting the intervals at which the main memory 10 is accessed, and completing the transfer by the time the instructions that refer to the continuous area are executed as described above, it becomes possible to use the cache memory 110 efficiently.

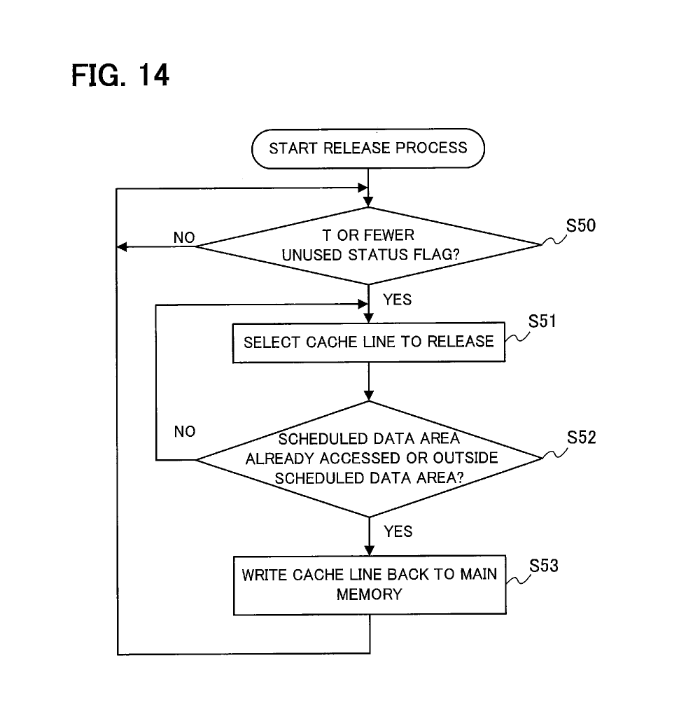

FIG. 14 is a flowchart illustrating the process performed by the release processing unit 144 in the data processing unit 140. The release processing unit 144 constantly monitors whether or not the number of status flags Fs in the tag memory 121 of the memory management unit 120 that indicate invalid locations (where data are not stored) is equal to or less than a predetermined value, T for example.

The release processing unit 144 decides whether or not the number of status flags Fs is equal to or less than T (S50). If the number of status flags Fs is more than T (No in S50), the release processing unit 144 waits while continuing to monitor the status flags Fs in the memory management unit 120. Conversely, if the number of status flags Fs is equal to or less than T (Yes in S50), the process proceeds to step S51.

In step S51, the release processing unit 144 selects a candidate cache line to release among the cache lines on the cache memory 110. As a method of selecting a cache line as a candidate for release, for example, the LRU method, which selects the cache line that has not been referred to for the longest time, is used.

The release processing unit 144 then decides whether or not the cache line selected in step S51 is releasable (S52). Among the cache lines on the cache memory 110, cache lines in which data transferred by a transfer scheduling command C3 are stored and which have not been accessed from the access master 1 even once cannot be released. In other words, the cache lines that can be released are, among the cache lines selected as candidates for release, cache lines transferred to the cache memory 110 by request commands C2 and, among the cache lines selected as candidates for release, cache lines for which a scheduled area access flag Fra indicates that the access flag Fa has become valid. Accordingly, the release processing unit 144 monitors the access flags Fa of cache lines on which data are stored by the schedule processing unit 143 and records scheduled area access flags Fra in a memory 144a indicating whether or not the access flags Fa have become valid one or more times.

If the cache line selected in step S51 is not releasable (No in S52), the process then returns to step S51, where the release processing unit 144 again selects a cache line as a candidate for release by the LRU method. Conversely, if the cache line selected in step S51 is releasable (Yes in S52), the process proceeds to step S53.

In step S53, the release processing unit 144 gives the cache memory access arbitration unit 145 an instruction to write the data stored in the releasable cache line back to the main memory 10 (S53). Upon reception of this instruction, the cache memory access arbitration unit 145 reads the data stored in the cache line decided to be releasable and provides the data to the release processing unit 144. The release processing unit 144 provides the data to the main memory access arbitration unit 146 to have the data written into the main memory 10.

When the writing of the cache line from the cache memory 110 back to the main memory 10 is completed, the process returns to step S50 and the release processing unit 144 continues monitoring the status flags Fs in the tag memory 121.

Making cache lines in which data transferred by a transfer scheduling command C3 are stored and which have not been accessed by the access master 1 even once not subject to release, as described above, assures that data referred to by the access master are stored in the cache memory 110.

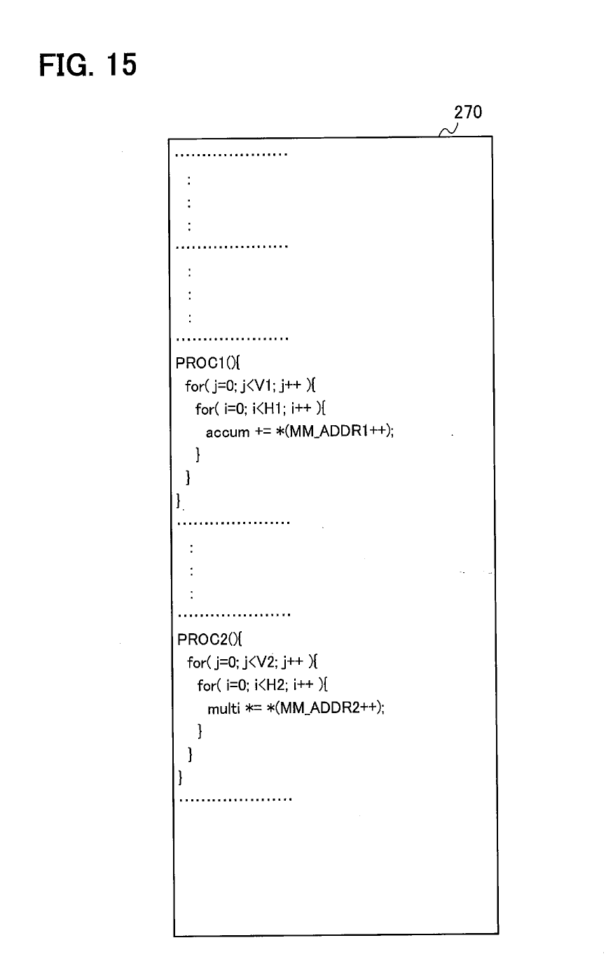

In the first embodiment described above, an example has been described in which a first program 180 (see FIG. 6) generated by coding transfer scheduling functions 171, 172 in a second program 170 as shown in FIG. 3 and compiling them with a compiler Cgc is used to operate the cache memory controller 100, but this type of example is not limiting. All that is required is for transfer scheduling commands to be coded in the first program. Accordingly, a compiler that generates a first program 180 including transfer scheduling commands 181a to 181c and 182a to 182c as shown in FIG. 6 from a second program 270 of the type shown in FIG. 15 may also be used. In other words, the compiler may generate the transfer scheduling instructions included in the second program by analyzing code indicating instructions that use data stored in the data area in the main memory 10. This enables the desired purpose to be accomplished by coding transfer scheduling commands at appropriate positions without fail, even when no transfer scheduling function 160 is intentionally coded in the second program 270.

In the first embodiment described above, an example has been described in which transfer scheduling commands are issued from the access master 1, but this type of example is not limiting. For example, the first program executed by the access master 1 may not include any transfer scheduling instructions. In this case, it suffices for the schedule processing unit 143 to analyze the first program, which is stored in a prescribed program area on the main memory 10 and has been stored in the cache memory 110, and generate transfer scheduling information for transferring data referred to by a process executed later from the main memory 10 to the cache memory 110. This enables the first program to be generated from the second program by use of a general-purpose compiler and data referred to by the access master 1 to be reliably stored in the cache memory 110.

### Second Embodiment

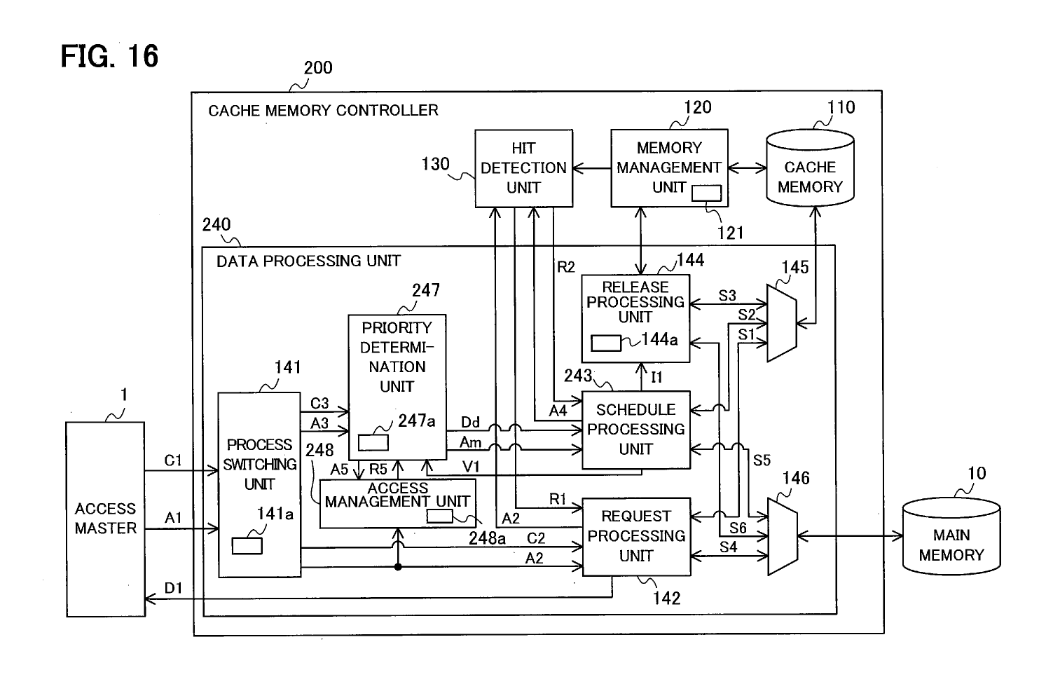

The second embodiment will be described with reference to FIGS. 16 to 30.

FIG. 16 is a block diagram schematically showing the configuration of a cache memory controller 200 according to the second embodiment. The cache memory controller 200 includes a cache memory 110, a memory management unit 120, a hit detection unit 130, and a data processing unit 240.

FIG. 16 shows the connection relationships among an access master 1, the cache memory controller 200, and the main memory 10 in a simplified form.

The main memory 10 is managed in collective units of a certain capacity, referred to as banks. A bank is divided into an instruction area and a data area. It is possible to access a specific continuous area by designating its row (Row) address and column (Column) address in the main memory 10.

The functions of the cache memory 110, memory management unit 120, and hit detection unit 130 are the same as in the first embodiment and have already been described, so descriptions will be omitted here.

The data processing unit 240 transfers the data stored in the main memory 10 to the cache memory 110. In this embodiment, each time the data processing unit 240 receives transfer scheduling information including an address at which data used by a specific instruction are stored in the main memory 10, it stores the received transfer scheduling information. When a plurality of items of transfer scheduling information are stored, the data processing unit 240 arbitrates among them. Acting on transfer scheduling information of high priority as decided by arbitration, the data processing unit 240 transfers the data used by the specific instruction from the main memory 10 to the cache memory 110 before the access master 1 executes the specific instruction, which is included in the first program. The data processing unit 240 also writes data in the cache memory 110 or main memory 10 in response to requests from the access master 1. The data processing unit 240 includes a process switching unit 141, a request processing unit 142, a schedule processing unit 243, a release processing unit 144, a cache memory access arbitration unit 145, a main memory access arbitration unit 146, a priority determination unit 247, and an access management unit 248.

The functions of the process switching unit 141, request processing unit 142, release processing unit 144, cache memory access arbitration unit 145, and main memory access arbitration unit 146 are the same as in the first embodiment and have already been described, so descriptions will be omitted here.

The priority determination unit 247 receives a current address A3 and a transfer scheduling command C3 from the process switching unit 141. The priority determination unit 247 then stores the transfer scheduling information indicated by the received transfer scheduling command C3 in a memory 247a (transfer schedule storage unit). The priority determination unit 247 calculates an access interval Da for each item of stored transfer scheduling information. The method of calculating the access interval Da is the same as in the first embodiment. On the basis of the calculated access interval Da and a time since last access R5 obtained from the access management unit 248, the priority determination unit 247 decides which item of transfer scheduling information is to be processed by the schedule processing unit 243 with top priority. The priority determination unit 247 provides the access management unit 248 with the starting address Am of the continuous area in which the data to be transferred are stored, indicated by the transfer scheduling information, as an address A5, and in response thereto, receives the time since last access R5 from the access management unit 248. In addition, the priority determination unit 247 provides the schedule processing unit 243 with the access interval Da of the determined transfer scheduling information of highest priority for the continuous area on the main memory 10 and the starting address Am of the continuous area in which the data to be transferred are stored. When a scheduled transfer status signal V1 from the schedule processing unit 243 indicates the completion of transfer and the entire size H*V, stored as transfer scheduling information, of the continuous area in which the data to be transferred are stored has been transferred, the priority determination unit 247 deletes the transfer scheduling information from memory 247a.

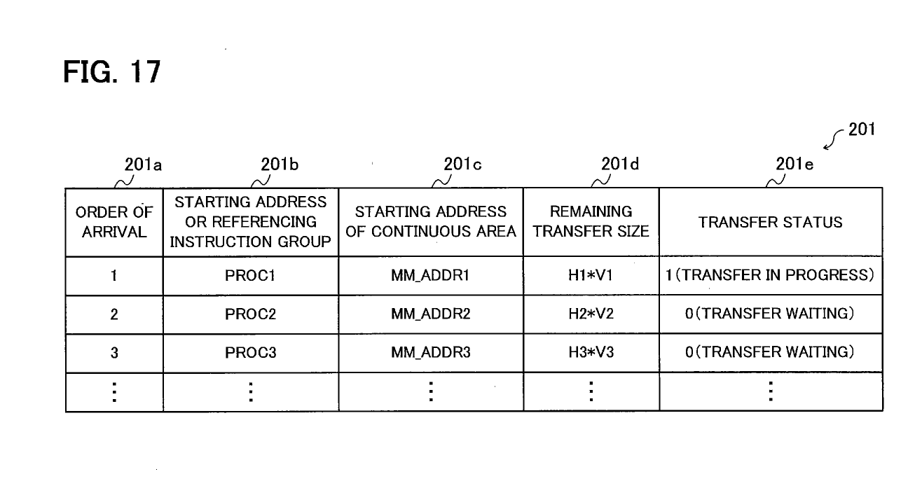

FIG. 17 is a schematic, diagram showing the transfer scheduling management information 201 stored in the memory 247a in the priority determination unit 247. The transfer scheduling management information 201 includes an order of arrival column 201a, a starting address of referencing instruction group column 201b, a starting address of continuous area column 201c, a remaining transfer size column 201d, and a transfer status column 201e.

The order of arrival column 201a stores information indicating the order of arrival of transfer scheduling information.

The starting address of referencing instruction group column 201b stores the starting address PROC of a group of instructions constituting a function that refers to a continuous area in which data to be transferred are stored.

The starting address of continuous area column 201c stores the starting address of the continuous area in which the data to be transferred according to the transfer scheduling command C3 are stored in the main memory 10. The initial value in the starting address of continuous area column 201c is the starting address MM_ADDR of the continuous area referred to by the access master 1 that is included in the transfer scheduling command C3.

The remaining transfer size column 201d stores the remaining size of the data to be transferred according to the transfer scheduling command C3. The initial value in the remaining transfer size column 201d is the size H*V of the continuous area in which the data to be transferred are stored that is included in the transfer scheduling command C3.

The transfer status column 201e stores transfer status information indicating whether or not the data transfer is currently in progress, based on the transfer scheduling information corresponding to the information stored in the starting address of referencing instruction group column 201b and starting address of continuous area column 201c. In this embodiment, for example, a ‘1’ in this field indicates that the data transfer is in progress; a ‘0’ indicates that the transfer is currently waiting.

The priority determination unit 247 stores the starting addresses MM_ADDR of continuous areas referred to by the access master 1, the sizes H*V of the continuous areas in which the data to be transferred are stored, and the starting addresses PROC of the groups of instructions constituting the functions that refer to the continuous areas in which the data to be transferred are stored, as indicated by transfer scheduling commands C3, in the scheduling management information 201 as transfer scheduling information, in the order in which the transfer scheduling commands C3 are received. The priority determination unit 247 updates the information stored in memory 247a when it receives a scheduled transfer status signal V1 from the schedule processing unit 243.

Returning to FIG. 16, the access management unit 248 monitors the request addresses A2 sent from the process switching unit 141, uses a timer (not shown) to measure the time that elapses from the last previous access as a time since last access Td, and stores the measured time since last access Td in a memory 248a (time since last access storage unit). Each time a request address A2 is sent from the process switching unit 141 to the request processing unit 142, the access management unit 248 identifies the continuous area to which the request address A2 belongs, treating a continuous area consisting of a plurality of addresses divided into row addresses and column addresses belonging to the individual banks on the main memory 10 as a single unit, and resets the time since last access Td of the identified continuous area. When provided with an address A5 from the priority determination unit 247, the access management unit 248 identifies the continuous area to which the address A5 belongs, reads the time since last access Td of the identified continuous area from the memory 248a as a response R5, and provides it to the priority determination unit 247.

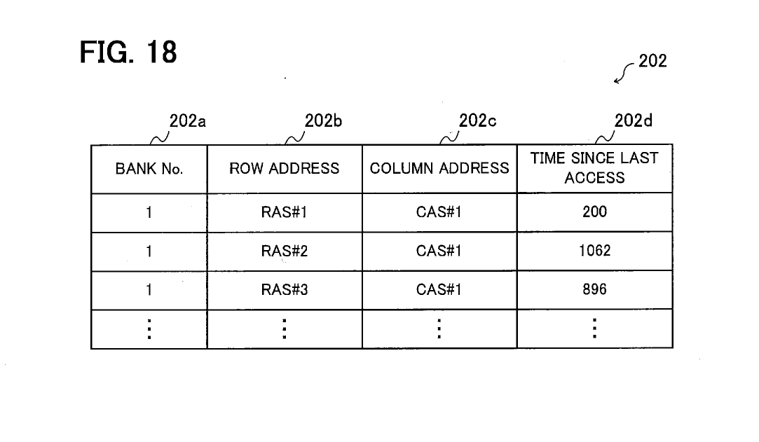

FIG. 18 is a schematic diagram showing access management information 202 stored in the memory 248a of the access management unit 248.

The access management information 202 includes a bank number column 202a, a row address column 202b, a column address column 202c, and a time since last access column 202d.

The bank number column 202a stores bank numbers that identify the banks in the main memory 10.

The row address column 202b stores row address ranges of continuous areas formed in the banks in the main memory 10.

The column address column 202c stores column address ranges of continuous areas formed in the banks in the main memory 10.

The time since last access column 202d stores times since last access Td indicating elapsed times from when a continuous area identified by the row address column 202b and column address column 202c in the bank identified by the bank number column 202a was last accessed. For a continuous area that has not been accessed from the access master 1 even once, the time since last access Td is the elapsed time since the cache memory controller 200 was started up.

Returning to FIG. 16, the schedule processing unit 243 accesses the main memory 10 according to hit detection results R2 provided from the hit detection unit 130, and to the starting addresses Am of continuous areas in which data to be transferred are stored and access intervals Da of access to the main memory 10, which are provided from the priority determination unit 247, and transfers single lines of data, which are preset units of transfer, to the cache memory 110. When the transfer of a line of data to the cache memory 110 is completed, the schedule processing unit 243 updates the scheduled transfer status signal V1 to a value indicating transfer completion, thereby notifying the priority determination unit 247 of the completion of the transfer of a line of data. For example, the schedule processing unit 243 provides the starting address Am of a continuous area in which data to be transferred are stored, which it has received from the priority determination unit 247, to the hit detection unit 130 as an address A4. In response, the schedule processing unit 243 obtains a hit detection result R2 for the address A4 from the hit detection unit 130. Then, if the hit detection result R2 is a cache miss, the schedule processing unit 243 transfers the data at this address from the main memory 10 to the cache memory 110. When the schedule processing unit 243 starts the transfer at the starting address Am of a continuous area in which the data to be transferred are stored, it also provides the release processing unit 144 with scheduled area information I1 indicating the destination cache line in which the data will be stored. Finally, upon completion of the transfer of one line of data starting from the starting address Am of the continuous area in which the data to be transferred are stored, the schedule processing unit 243 updates the scheduled transfer status signal V1 to indicate that the transfer has been completed, thereby notifying the priority determination unit 247. The scheduled transfer status signal V1 is, for example, a one-bit signal that is set to H (1) when a transfer has been completed and the next transfer can be scheduled, and conversely is set to L (0) while further transfer scheduling is unavailable.

Next, the processing flow in the priority determination unit 247 will be described by use of a flowchart.

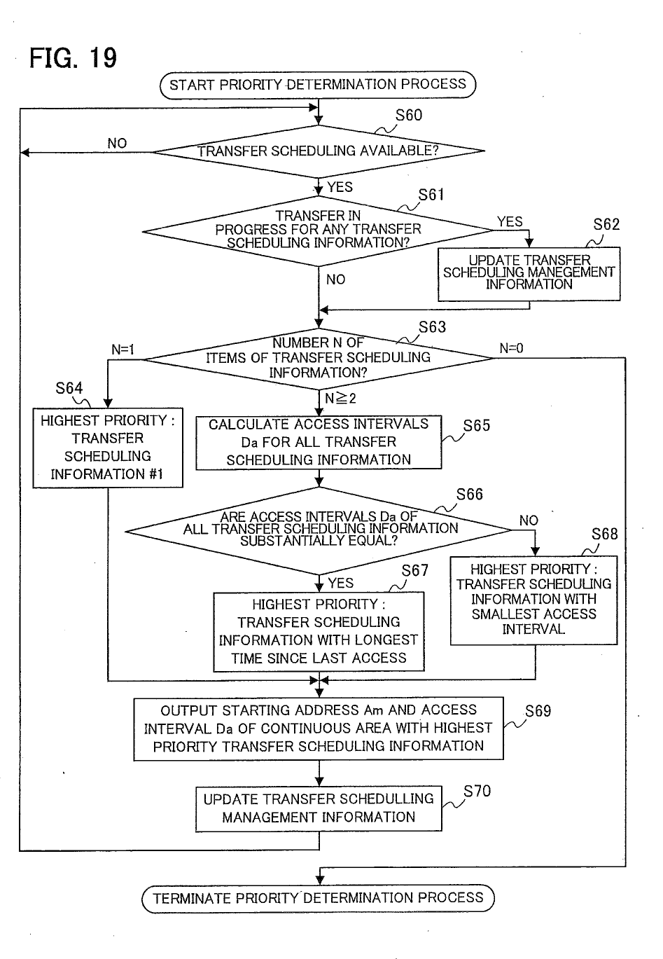

FIG. 19 is a flowchart illustrating the process when the priority determination unit 247 arbitrates among a plurality of items of transfer scheduling information. The priority determination unit 247 starts this process when it receives, from the process switching unit 141, a current address A3 and a transfer scheduling command C3 including the starting address MM_ADDR of a continuous area in which data to be transferred are stored, the size H*V of the continuous area in which the data to be transferred are stored, and the starting address PROC of an instruction group that refers to the continuous area in which the data to be transferred are stored.

First, the priority determination unit 247 decides whether or not the schedule processing unit 243 is busy (S60). If the scheduled transfer status signal V1 from the schedule processing unit 243 indicates that transfer scheduling is not available (V1=L) (No in S60), it waits until the transfer is completed. If the scheduled transfer status signal V1 from the schedule processing unit 243 indicates that transfer scheduling is available (V1=H) (Yes in S60), the priority determination unit 247 advances the process to step S61.

Next, in step S61, the priority determination unit 247 decides whether or not any transfer scheduling information for which the transfer status column 201e of the scheduling management information 201 stored in memory 247a indicates transfer-in-progress is present. If a ‘1’ indicating transfer-in-progress is stored in the transfer status column 201e of the scheduling management information 201 for any one item of the stored transfer scheduling information, (Yes in S61), the priority determination unit 247 advances the process to step S62. Conversely, if ‘0’, indicating transfer-waiting, is stored in the transfer status column 201e for all the stored transfer scheduling information (No in S61), the priority determination unit 247 advances the process to step S63.

In step S62, the priority determination unit 247 updates the record in which a ‘1’, indicating transfer-in-progress, is stored in the transfer status column 201e of the scheduling management information 201. Specifically, the priority determination unit 247 performs this update by subtracting the size (in this case, ‘1’, for example) of one line in the cache memory 10, which is the unit of transfer, from the value in the remaining transfer size column 201d in the relevant record in the scheduling management information 201. When the value in the remaining transfer size column 201d reaches ‘0’, the priority determination unit 247 deletes the transfer scheduling information (record). Conversely, when the value of the remaining transfer size column 201d is equal to or greater than ‘1’ even after the size of one line is subtracted from the value in the remaining transfer size column 201d, the priority determination unit 247 increments the starting address of the continuous area stored in the starting address of continuous area column 201c by one line. In other words, the priority determination unit 247 updates the starting address of the continuous area to the address one line farther on. In addition, the priority determination unit 247 updates the transfer status column 201e of the corresponding record to ‘0’ indicating transfer-waiting, and advances the process to step S63.

In step S63, the priority determination unit 247 determines the number of items of transfer scheduling information in the transfer-waiting state that are stored in memory 247a. If the number of items of such transfer scheduling information is ‘0’, the priority determination unit 247 terminates the processing flow. If the number of items of such transfer scheduling information is ‘1’, the priority determination unit 247 advances the process to step S64. If the number of items of such transfer scheduling information is ‘2’ or greater, the priority determination unit 247 advances the process to step S65.

In step S64, the priority determination unit 247 decides that the item of transfer scheduling information received from the process switching unit 141, in other words, the single item of transfer scheduling information stored in memory 247a, is the transfer scheduling information of highest priority. The process then proceeds to step S69.

In step S65, the priority determination unit 247 calculates an access interval Da for each item of transfer scheduling information stored in memory 247a. The process then proceeds to step S66. The access interval Da is calculated by expression (2) in the first embodiment.

Next, in step S66, the priority determination unit 247 decides whether or not the access intervals Da calculated for each item of transfer scheduling information in step S65 are substantially equal. If the differences among the access intervals Da of the items of transfer scheduling information are within a preset tolerance range, the priority determination unit 247 now decides that they are substantially equal (Yes in S66), and advances the process to step S67. If they are not substantially equal (No in S66), the priority determination unit 247 advances the process to step S68. The tolerance of the access interval Da has a preset value such, for example, as ‘±10’.

In step S67, the priority determination unit 247 determines the transfer scheduling information of highest priority on the basis of the times since last access R5 corresponding to the items of transfer scheduling information. For example, the priority determination unit 247 provides the addresses A5 stored in the starting address of continuous area column 201c of the scheduling management information 201 stored in memory 247a to the access management unit 248, and acquires the times since last access R5 in response. The priority determination unit 247 then decides that the transfer scheduling information with the greatest time since last access R5 is the transfer scheduling information of highest priority. The process now proceeds to step S69.

In step S68, among the access intervals Da for all the transfer scheduling information calculated in step S65, the priority determination unit 247 decides that the transfer scheduling information with the smallest access interval Da is the transfer scheduling information of highest priority. The process then proceeds to step S69.

In step S69, on the basis of the transfer scheduling information of highest priority determined in step S64, S67, or S68, the priority determination unit 247 takes the address stored in the corresponding starting address of continuous area column 201c in the scheduling management information 201 as the starting address Am of the continuous area in which the data to be transferred are stored. The priority determination unit 247 then provides the schedule processing unit 243 with the starting address Am of the continuous area in which the data to be transferred are stored and the access interval Da. The process now proceeds to step S70.

In step S70, among the transfer scheduling management information 201 stored in memory 247a, the priority determination unit 247 alters the transfer status of the transfer scheduling information it provides to the schedule processing unit 243 in step S69 from ‘0 (transfer waiting)’ to ‘1 (transfer in progress)’. The process then returns to step S60.

By determining the transfer scheduling information of highest priority from all the transfer scheduling information stored in memory 247a on the basis of the access intervals Da calculated from the current address A3, even for urgent transfer scheduling information, the priority determination unit 247 can complete the transfer of the required data before the access master 1 executes the group of instructions indicated by the starting address PROC, preventing waste of the cache memory 110.

In addition, by determining the transfer scheduling information of highest priority from all the transfer scheduling information stored in memory 247a on the basis of the access intervals Da calculated from the current addresses A3 and the time since last access R5 obtained from the access management unit 248, the priority determination unit 247 can improve the cache hit ratio even for a continuous area on the main memory 10 that could quite possibly be released from the cache memory 110.

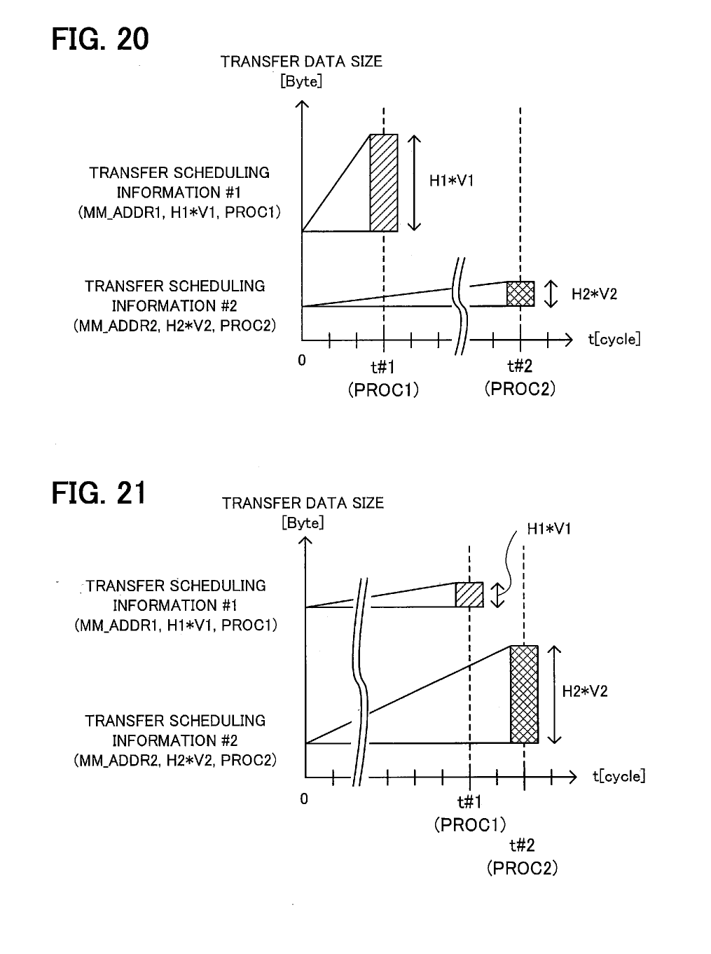

FIGS. 20 to 24 are schematic diagrams showing relationships, for two items of transfer scheduling information that the priority determination unit 247 receives from the process switching unit 141, among the sizes of the continuous areas in which the data to be transferred are stored and the starting addresses of the groups of instructions that refer to the continuous areas in which the data to be transferred are stored. The vertical axis in each of FIGS. 20 to 24 represents the size of the continuous area in which the data to be transferred are stored; the horizontal axis represents time. At time ‘0’, the priority determination unit 247 starts the process of determining the priority levels of transfer scheduling information #1 and transfer scheduling information #2, which it has received from the process switching unit 141. On the horizontal axis, t#1 and t#2 represent the timings at which execution reaches the starting addresses PROC1 and PROC2 of the instruction groups that refer to the continuous areas in which the data to be transferred are stored, as respectively indicated by the transfer scheduling information #1 and #2 received from the process switching unit 141. H1*V1 and H2*V2 represent the sizes of the continuous areas in which the data to be transferred are stored, as respectively indicated by the transfer scheduling information #1 and #2 received from the process switching unit 141.

FIGS. 20 and 21 shows examples in which the access intervals Da of the two items of transfer scheduling information are determined not to be substantially equal in step S66 in FIG. 19.

FIG. 20 shows an example in which, compared with transfer scheduling information #2, in transfer scheduling information #1 the size of the continuous area in which the data to be transferred are stored is larger and the number instruction steps to the starting address of the group of instruction referring to the continuous area in which the data to be transferred are stored is smaller, in other words, the time until to the execution of the instruction group that refers to the continuous area in which the data to be transferred are stored is shorter. In this case, the value of the access interval Da for transfer scheduling information #1, calculated in step S65 in FIG. 19, is smaller than the value for transfer scheduling information #2 by more than the tolerance. Accordingly, in step S66 in FIG. 19, it is determined that the access intervals Da of the transfer scheduling information are not substantially equal (No in S66), and the transfer scheduling information #1 with the shorter access interval Da is determined to be the transfer scheduling information of highest priority.

FIG. 21 is an example opposite to the one in FIG. 20: the priority determination unit 247 decides that transfer scheduling information #2 is the transfer scheduling information of highest priority. In FIG. 21, compared with transfer scheduling information #1, in transfer scheduling information #2 the size of the continuous area in which the data to be transferred are stored is larger, and the number instruction steps to the starting address of the instruction group that refers to the continuous area in which the data to be transferred are stored is also larger, in other words, the time until the execution of the instruction group that refers to the continuous area in which the data to be transferred are stored is longer. The period of time until the execution of the instruction group that refers to the continuous area in which the data to be transferred are stored begins is accordingly longer in transfer scheduling information #2, but the difference between the starting addresses PROC1 and PROC2 of the instructions referring to the continuous areas in which the data to be transferred are stored is small. The value of the access interval Da for transfer scheduling information #2, calculated in step S65 in FIG. 19, is therefore shorter than the value for transfer scheduling information #1 by more than the tolerance. Accordingly, in step S66 in FIG. 19, it is determined that the access intervals Da of the transfer scheduling information are not substantially equal (No in S66), and the transfer scheduling information #2 with the shorter access interval Da is determined to be the transfer scheduling information of highest priority.

The priority determination unit 247 determines as described above that the transfer scheduling information with the smallest access interval Da is the transfer scheduling information of highest priority, and provides the schedule processing unit 243 with the calculated access interval Da and the starting address Am of the continuous area in which the data to be transferred that are indicated by the transfer scheduling information of highest priority are stored. This eliminates the need for the schedule processing unit 243 to calculate access intervals Da, speeding up the start of the scheduling process, so the efficiency of data transfer from the main memory 10 to the cache memory 110 can be improved.

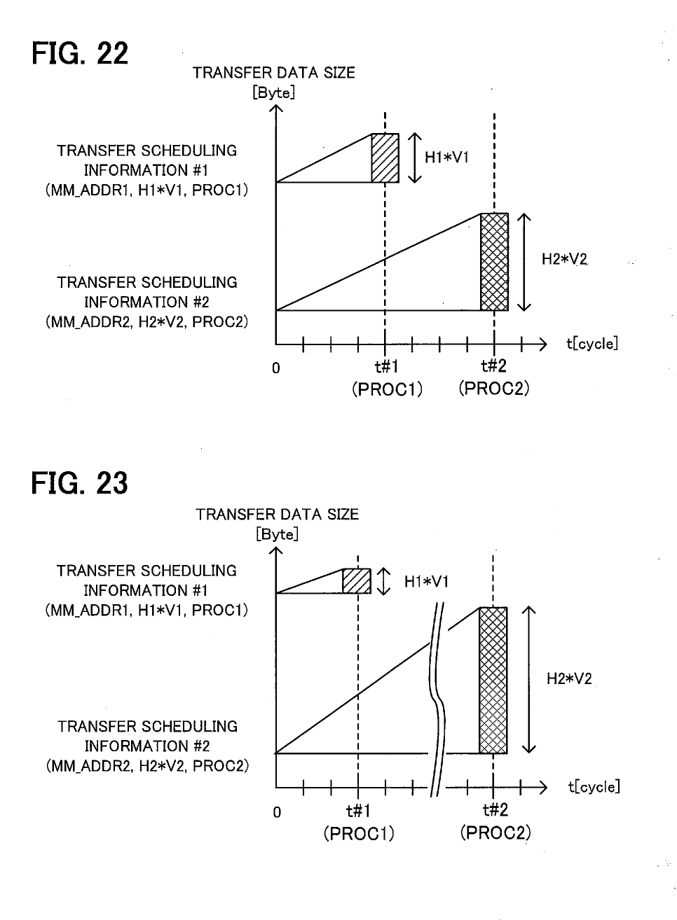

FIGS. 22 to 24 are examples in which the access intervals Da of the two items of transfer scheduling information are determined to be substantially equal.

In FIG. 22, in both transfer scheduling information #1 and transfer scheduling information #2, the number of instruction steps to the starting address of the instruction group that refers to the continuous area in which the data to be transferred are stored is small in relation to the size of the continuous area in which the data to be transferred are stored. For this reason, the values of the access intervals Da calculated in step S65 in FIG. 19 are both about equally small, and the access intervals Da of both items of transfer scheduling information are determined to be substantially equal.

In FIG. 23, in transfer scheduling information #1, the size of the continuous area in which the data to be transferred are stored is very small but the number of instruction steps to the starting address of the instruction group that refers to the continuous area in which the data to be transferred are stored is also small. In transfer scheduling information #2, conversely, the size of the continuous area in which the data to be transferred are stored is large but the number of instruction steps to the starting address of the instruction group that refers to the continuous area in which the data to be transferred are stored is also large. For this reason, the values of the access intervals Da calculated in step S65 in FIG. 19 are both about equally small, and the access intervals Da of both items of transfer scheduling information are determined to be substantially equal.

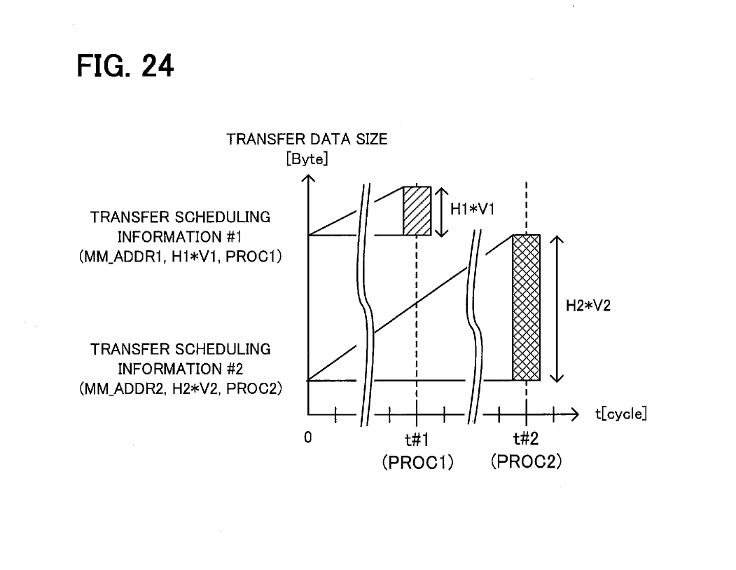

In FIG. 24, in transfer scheduling information #1, the size of the continuous area in which the data to be transferred are stored is large and the number of instruction steps to the starting address of the group of instructions referring to the continuous area in which the data to be transferred are stored is also quite large. In transfer scheduling information #2, the size of the continuous area in which the data to be transferred are stored is very large and the number of instruction steps to the starting address of the instruction group that refers to the continuous area in which the data to be transferred are stored is also very large. For this reason, the values of the access intervals Da calculated in step S65 in FIG. 19 are both about equally large, and the access intervals Da of both items of transfer scheduling information are determined to be substantially equal.

In all of FIGS. 22 to 24, if the time since last access R5 of transfer scheduling information #2 is shorter than that of transfer scheduling information #1, then transfer scheduling information #1, which has the longer time since last access R5, is determined to be the transfer scheduling information of highest priority in step S67 in FIG. 19. Conversely, if the time since last access R5 of transfer scheduling information #2 is longer than that of transfer scheduling information #1, then transfer scheduling information #2, which has the longer time since last access R5, is determined to be the transfer scheduling information of highest priority in step S67 in FIG. 19.

By determining the transfer scheduling information with the largest time since last access R5 to be the transfer scheduling information of highest priority as described above, given even a plurality of items of transfer scheduling information for which the access intervals Da calculated by the priority determination unit 247 are substantially equal, it is possible to prevent the release of continuous areas that are highly likely to be released from the cache memory 110, thereby speeding up the processing in the cache memory controller 200.

As shown in FIG. 23, when the calculated access intervals Da are both small and the difference between the respective starting addresses PROC1 and PROC2 of the instruction groups that refer to the individual continuous areas in which the data to be transferred are stored that are included in transfer scheduling information #1 and transfer scheduling information #2 is large, the priority determination unit 247 decides that the transfer scheduling information with the largest time since last access R5 is the transfer scheduling information of highest priority, but this is not a limitation. For example, when the access intervals Da are equal to or less than a first preset threshold value and the difference between the starting addresses PROC1 and PROC2 of the instruction groups that refer to the continuous areas in which the data to be transferred are stored is equal to or greater than a second preset threshold value, the priority determination unit 247 may decide that the transfer scheduling information in which the starting address of the instruction group that refers to the continuous area in which the data to be transferred are stored is the smallest is the transfer scheduling information of highest priority. This can prevent waste of the cache memory 110, because the cache memory 110 does not store data unnecessarily.

As shown in FIG. 24, the priority determination unit 247 also decides that the transfer scheduling information with the greatest time since last access R5 is the transfer scheduling information of highest priority when both the size of the continuous area in which the data to be transferred are stored and the number of instruction steps to the starting address of the instruction group that refers to the continuous area in which the data to be transferred are stored are larger in transfer scheduling information #2 than in transfer scheduling information #1 and the values of the access intervals Da calculated in step S65 in FIG. 19 are substantially equal, but this is not a limitation. For example, if the calculated access intervals Da are equal to or greater than a first preset threshold value, the priority determination unit 247 may wait until an access interval Da becomes equal to or less than the first threshold value, or until the next transfer scheduling information is input. By doing this, even when the priority determination unit 247 receives transfer scheduling information with an access interval Da smaller than that of previously received transfer scheduling information, it can give priority to processing the transfer scheduling information with the smaller access interval Da, and can thereby use the cache memory 110 efficiently.

In the examples described above there were two items of transfer scheduling information stored in the memory 247a in the priority determination unit 247, but this may not be true in practice. Even when three or more items of transfer scheduling information are stored in memory 247a, waste of the cache memory 110 can be prevented by determining the transfer scheduling information of highest priority on the basis of the access intervals Da and the times since last access in the same way as above.

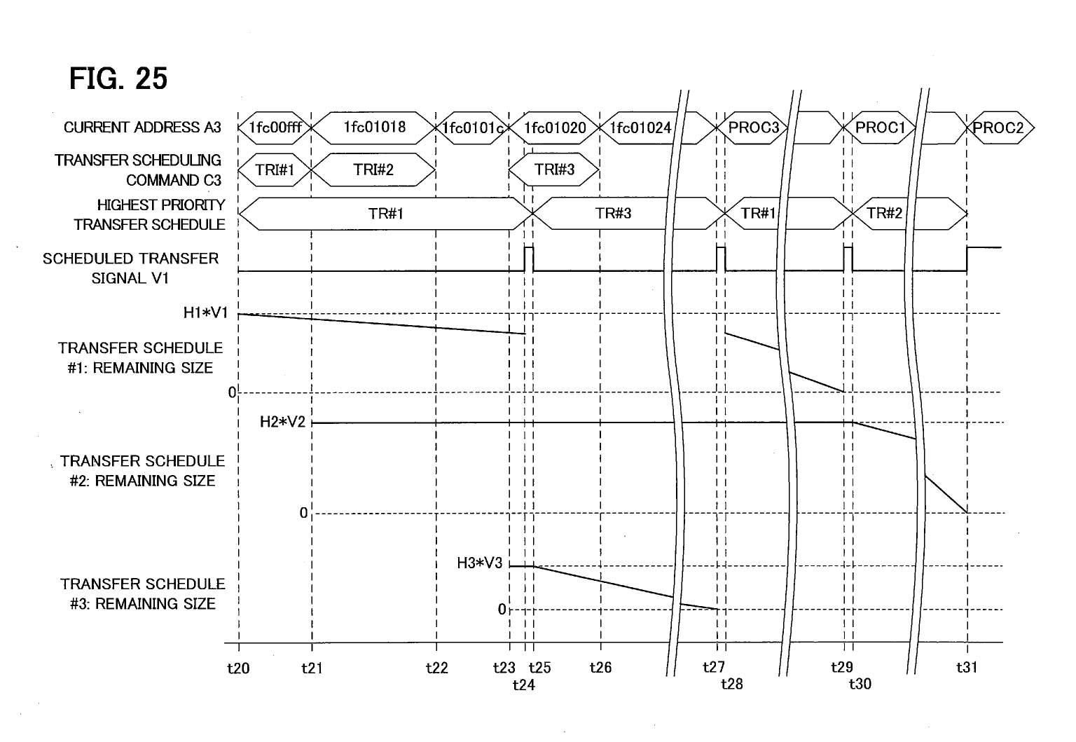

FIG. 25 is a schematic diagram showing an exemplary timing diagram of the process performed by the priority determination unit 247. FIG. 25 shows timings at which a current address A3 and an instruction command C3 are input from the process switching unit 141, timings at which the transfer scheduling information of highest priority is determined, and timings at which the size of the remaining data to be transferred changes, based on a plurality of items of transfer scheduling information that the priority determination unit 247 receives from the process switching unit 141.

At time t20, upon input of a current address A3 (1fc00fff) and a transfer scheduling command C3 (TRI#1) input from the process switching unit 141, the priority determination unit 247 stores transfer scheduling information (TR#1) in memory 247a on the basis of the transfer scheduling command C3. The priority determination unit 247 then determines the transfer scheduling information of highest priority. At time t20, since TR#1 is the only transfer scheduling information that has been received, the priority determination unit 247 decides that TR#1 is the transfer scheduling information of highest priority. The priority determination unit 247 now outputs an access interval Da and the starting address Am of the continuous area to the schedule processing unit 243, and the transfer scheduling process begins. Processing in the priority determination unit 247 then waits until time t24, when the schedule processing unit 243 has completed the transfer of one line of data within the size H1*V1, designated by TR#1, of the continuous area in which the data to be transferred are stored and the scheduled transfer status signal V1 goes to the transfer scheduling available state (V1=H).

From time t21 to time t23, the current address A3 and transfer scheduling command C3 input to the priority determination unit 247 from the process switching unit 141 are updated. The priority determination unit 247 stores transfer scheduling information (TR#2) in memory 247a on the basis of a transfer scheduling command C3 (TRI#2) input at time t21, and stores transfer scheduling information (TR#3) in memory 247a on the basis of a transfer scheduling command C3 (TRI#3) input at time t23. However, since the scheduled transfer status signal V1 is in the transfer scheduling unavailable state (V1=L), processing in the priority determination unit 247 is kept waiting.

Next, at time t24, since the scheduled transfer status signal V1 from the schedule processing unit 243 goes to the transfer scheduling available state (V1=H), the priority determination unit 247 starts the process of determining the transfer scheduling information of highest priority.

At time t25, the priority determination unit 247 decides that TR#3 is the transfer scheduling information of highest priority, and outputs the starting address Am of the continuous area and an access interval Da to the schedule processing unit 243, thereby starting the scheduling process.

At time t27, the transfer of one line of data in the continuous area in TR#3 is completed and the scheduled transfer status signal V1 from the schedule processing unit 243 goes to the transfer scheduling available state (V1=H) so, as at time t24, the priority determination unit 247 starts the process of determining the transfer scheduling information of highest priority. Here, TR#2 is determined to be the transfer scheduling information of highest priority.

After this, similarly, at every timing when the scheduled transfer status signal V1 from the schedule processing unit 243 goes to the transfer scheduling available state (V1=H), the priority determination unit 247 determines the transfer scheduling information of highest priority, and outputs the starting address Am and access interval Da of the continuous area in the transfer scheduling information of highest priority to the schedule processing unit 243. Then, if the scheduled transfer status signal V1 from the schedule processing unit 243 is in the transfer scheduling unavailable state (V1=L), the process in the priority determination unit 247 is kept waiting.

Finally, at time t31, upon completion of the transfer for the last transfer scheduling information (TR#2) stored in the memory 247a in the priority determination unit 247, the scheduled transfer status signal V1 from the schedule processing unit 243 is held in the transfer scheduling available state (V1=H) until a transfer scheduling command C3 is input from the process switching unit 141, and processing in the priority determination unit 247 waits.

By determining the transfer scheduling information of highest priority from all the items of transfer scheduling information stored in memory 247a each time the transfer of one line of data, which is the preset unit transfer size, is completed according to transfer scheduling information as described above, and completing the transfers before the instruction groups that refers to the corresponding continuous areas are executed, the priority determination unit 247 can improve the efficiency of data transfer to the access master 1.

Next, the processing flow executed by the schedule processing unit 243 in the data processing unit 240 will be described by use of a flowchart.

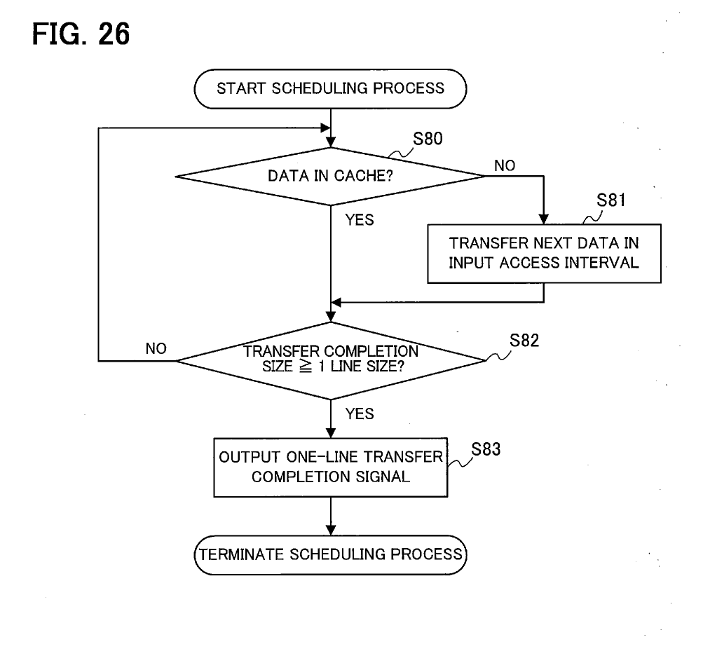

FIG. 26 is the flowchart illustrating the process when the schedule processing unit 243 transfers data on the basis of a transfer scheduling command C3. The schedule processing unit 243 starts this process when it receives, as inputs, a hit detection result R2 indicating a cache hit or a cache miss from the hit detection unit 130, and a main memory access interval Da and the starting address Am of a continuous area in which data to be transferred are stored from the priority determination unit 247.

First, the schedule processing unit 243 decides whether or not data corresponding to the starting address Am are present in the cache memory 110 (S80). Here, the data corresponding to the starting address Am are data having a unit transfer length stored from the starting address Am. The schedule processing unit 243 uses the hit detection result R2 from the hit detection unit 130 to make this decision. If the data corresponding to the starting address Am are not present in the cache memory 110 (No in S80), the data must be transferred from the main memory 10 to the cache memory, so the schedule processing unit 243 advances the process to step S81. Conversely, if the data corresponding to the starting address Am are present in the cache memory 110 (Yes in S80), the data need not be transferred from the main memory 10 to the cache memory 110, so the schedule processing unit 243 advances the process to step S82 without transferring the data.

In step S81, the schedule processing unit 243 gives the main memory access arbitration unit 146 an instruction to transfer the data from the main memory 10 to the cache memory 110 in the access interval Dd input from the priority determination unit 247. Having received an instruction to perform a transfer, the main memory access arbitration unit 146 reads the data to be transferred from the main memory 10 and provides the data to the schedule processing unit 243. The schedule processing unit 243 provides the provided data to the cache memory access arbitration unit 145 to have the data written into the cache memory 110. The subsequent processing by the memory management unit 120 is the same as in the first embodiment, so a description will be omitted.

Next, the schedule processing unit 243 decides whether or not the transfer completion size is equal to or greater than the size of one line, which is the unit transfer size (S82). If the transfer completion size is less than the size of one line (No in S82), the process returns to step S80; if the transfer completion size is equal to or greater than the size of one line (Yes in S82), the process proceeds to step S83.

In step S83, the schedule processing unit 243 sets the scheduled transfer status signal V1 to the transfer scheduling available state (V1=H), indicating that the transfer of one line of data from the starting address Am of the continuous area in which the data to be transferred are stored has been completed, outputs the signal to the priority determination unit 247, and terminates the scheduling process.

By transferring one line of data at a time in the transfer scheduling information input from the priority determination unit 247 as described above, the schedule processing unit 243 can use the cache memory 110 efficiently.

Although the transfer of one line of data at a time from the continuous area, designated by the transfer scheduling command C3, in which the data to be transferred are stored was described as an example in the above processing flow of the schedule processing unit 243, this example is not limiting. For example, the priority determination unit 247 may determine the transfer scheduling information of highest priority whenever a current address A3 is input from the process switching unit 141 to the priority determination unit 247 and output it to the schedule processing unit 243, and the schedule processing unit 243 may perform a transfer scheduling process accordingly. In this case, in calculating the access interval Da, it is necessary to consider the precharge time occurring for each access to areas with different row (Row) addresses in the main memory 10. This enables transfers from the main memory 10 to the cache memory 110 to be made even for a plurality of items of transfer scheduling information having small access intervals Da, resulting in an increase in the cache hit ratio.

An exemplary method of calculating the access interval Da by allowing for the precharge time will now be described.

First, the priority determination unit 247 determines whether or not the precharge time needs to be considered. Precharge time occurs due to different Row addresses on the main memory 10. Therefore, the priority determination unit 247 stores the address of the data in the continuous area in the previously determined transfer scheduling information of highest priority in memory 247a and compares Row addresses to decide whether or not there is a difference between the Row address in the transfer scheduling information of the previous transfer and the Row address in the transfer scheduling information of the current transfer. If there is a difference between the Row addresses, the priority determination unit 247 allows for precharge time. Since the access interval Da is the number of instruction steps required for a transfer of unit transfer size, the precharge time Tpri (cycles) is converted to a number of instruction steps. The conversion of the precharge time Tpri to a number of instruction steps is carried out by the following equation (3).

[Mathematical Expression 1]

Converted precharge Spri=(Number of cycles(Tos)taken for one instruction step)÷(Precharge time Tpri) (3)

Here, in equation (3), the priority determination unit 247 is furnished with a timer in advance, measures the number of cycles Tos taken to execute one measured instruction step, and uses that value to convert the precharge time. The number of cycles Tos taken to execute an instruction step is the number of cycles from the previous instruction to the current instruction, or the average number of cycles taken per instruction execution up to the current instruction.

The access interval Dap allowing for precharge time is calculated by equation (4) using the converted precharge Spri calculated by expression (3).

[Mathematical Expression 2]

Dap=(access interval Da)−(converted precharge Spri) (4)

As the unit of transfer, the schedule processing unit 243 may use the size H*V of the continuous area in which the data to be transferred are stored, which is indicated by transfer scheduling information. In this case, the size H*V of the continuous area in which the data to be transferred are stored is provided from the priority determination unit 247 to the schedule processing unit 243, and after the transfer is completed, the scheduled transfer status signal V1 is placed in the transfer scheduling available state (V1=1). This can reduce the processing involved in determining the transfer scheduling information of highest priority and accordingly shorten the calculation time needed for determining the transfer scheduling information of highest priority, which can improve the efficiency of data transfer from the main memory 10 to the cache memory 110.

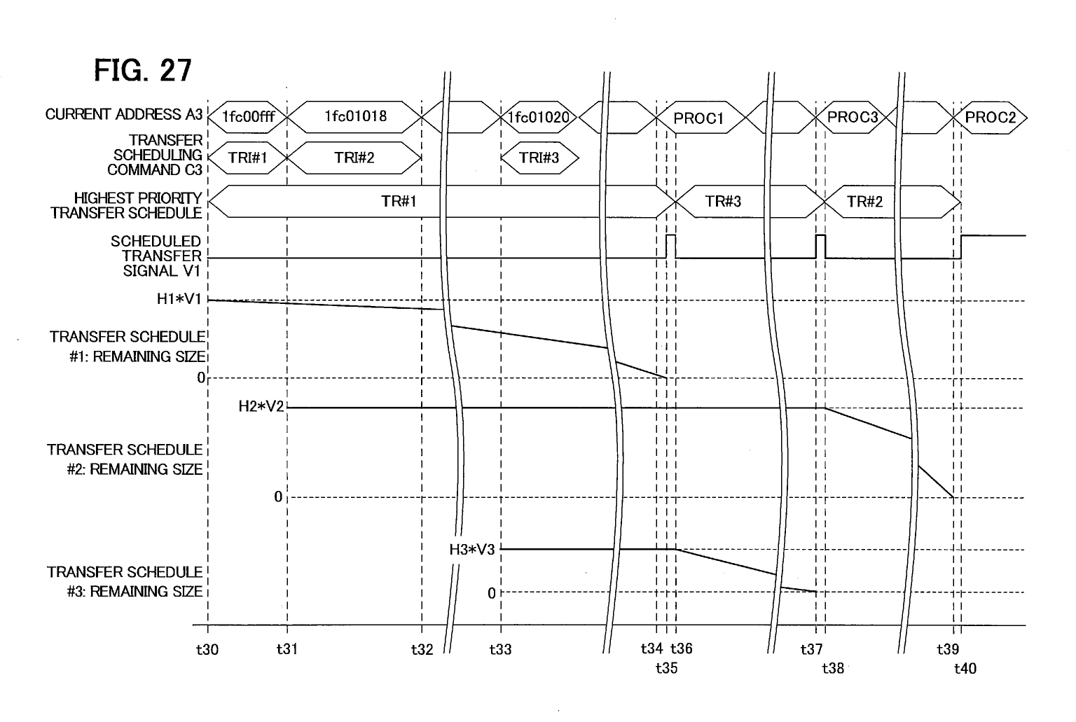

FIG. 27 is a schematic drawing showing an exemplary timing diagram of the process executed by the priority determination unit 247 when the unit of transfer in the schedule processing unit 243 is set to the size H*V of the continuous area in which the data to be transferred are stored, as indicated by transfer scheduling information. FIG. 27 shows timings at which current addresses A3 and instruction commands C3 are input from the process switching unit 141, timings at which the transfer scheduling information of highest priority is determined, and timings at which the size of the remaining continuous area in the continuous area in which the data to be transferred are stored is switched on the basis of a plurality of items of transfer scheduling information that the priority determination unit 247 receives from the process switching unit 141.

At time t30, when a current address A3 (1fc00fff) and a transfer scheduling command C3 (TR1#1) are input from the process switching unit 141, the priority determination unit 247 stores transfer scheduling information (TR#1) in memory 247a on the basis of the transfer scheduling command C3. The priority determination unit 247 then determines the transfer scheduling information of highest priority. At time t30, TR#1 is the only transfer scheduling information that the priority determination unit 247 has received, so the priority determination unit 247 decides that TR#1 is the transfer scheduling information of highest priority. The priority determination unit 247 then outputs, to the schedule processing unit 243, the starting address PROC1 of the continuous area in which the data to be transferred are stored and the size H*V of the continuous area in which the data to be transferred are stored, as indicated by TR#1, and the calculated access interval Da, and the scheduling process begins.

From time t31 to t35, the current address A3 and transfer scheduling command C3 input from the process switching unit 141 to the priority determination unit 247 are updated. The priority determination unit 247 stores transfer scheduling information (TR#2) in memory 247a on the basis of a transfer scheduling command C3 (TRI#2) input at time t31, and stores transfer scheduling information (TR#3) in memory 247a on the basis of a transfer scheduling command C3 (TRI#3) input at time t33. However, the scheduled transfer status signal V1 from the schedule processing unit 243 is in the transfer scheduling unavailable state (V1=L), so processing in the priority determination unit 247 is kept waiting.

At time t35, the scheduled transfer status signal V1 goes to the transfer scheduling available state (V1=H), so the priority determination unit 247 determines the next transfer scheduling information of highest priority.

At time t36, the priority determination unit 247 decides that TR#3 is the transfer scheduling information of highest priority. The priority determination unit 247 then outputs, to the schedule processing unit 243, the starting address PROC3 of the continuous area in which data to be transferred are stored and the size H*V of the continuous area in which data to be transferred are stored, as indicated by TR#3, which has been determined to be the transfer scheduling information of highest priority, and the calculated access interval Da, and the scheduling process begins. Processing in the priority determination unit 247 is then kept waiting until the scheduled transfer status signal V1 input from the schedule processing unit 243 goes to the transfer scheduling available state (V1=H).

After that, in the same way as the above, when the scheduled transfer status signal V1 goes to the transfer scheduling available state (V1=H) at time t37, the priority determination unit 247 determines the transfer scheduling information of highest priority again and outputs, to the schedule processing unit 243, the starting address PROC2 of the continuous area in which the data to be transferred are stored and the size H2*V2 of the continuous area in which the data to be transferred are stored, as indicated by the transfer scheduling information #2 that has been determined to be the transfer scheduling information of highest priority, and the calculated access interval Da. Processing then waits until the scheduled transfer status signal V1 input from the schedule processing unit 243 goes to the transfer scheduling available state (V1=H).

The access management unit 248 described above stores the time that has elapsed from the previous access in the memory 248a as a time since last access Td, but this is not a limitation. For example, the access management unit 248 may reset the time since last access Td when the time that has elapsed from the previous access exceeds the time set by the LRU method for deciding on a candidate line to be released among the cache lines in the cache memory 110. This enables transfer scheduling information for transferring data stored in a continuous area on the main memory 10 that is stored in a cache line highly likely to be released from the cache memory 110 to be output to the schedule processing unit 243 on a preferential basis. Accordingly, it is possible to reduce the number of times the release processing unit 144 carries out the release process, thereby speeding up the processing in the cache memory controller 200.

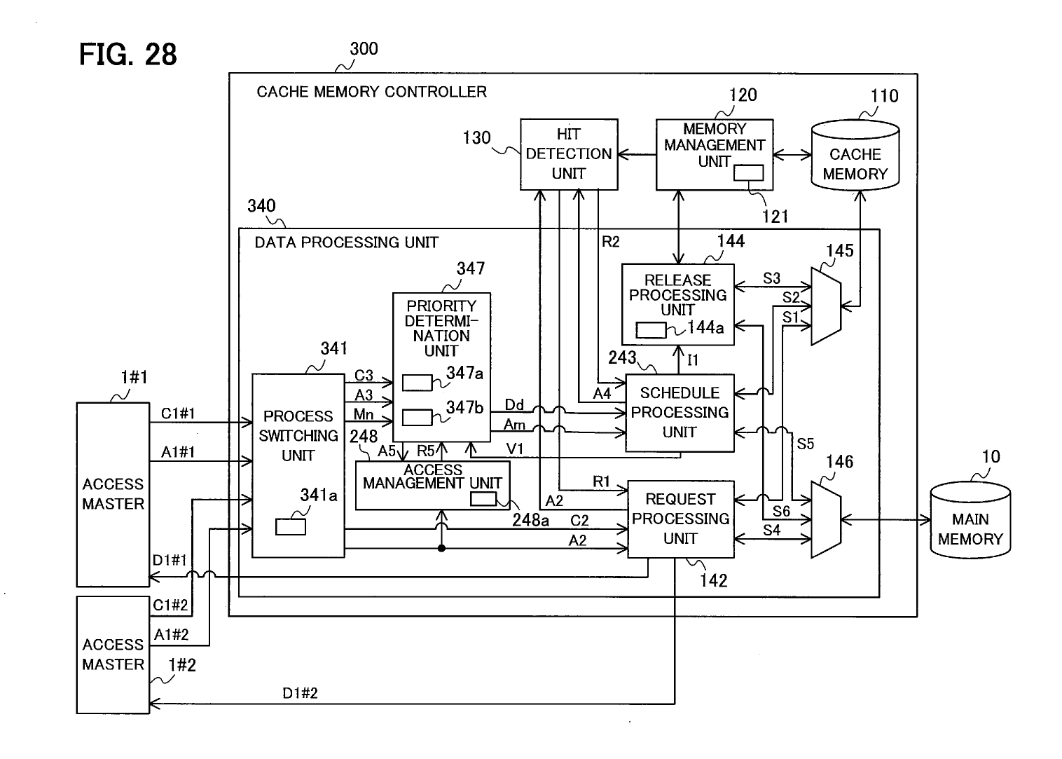

The cache memory controller 200 described above has been described as having a single access master 1, but this example is not limiting. Multiple access masters 1 may be connected to the cache memory controller 200. FIG. 28 is a schematic diagram showing an example in which two access masters, access master 1#1 and access master 1#2, are connected to a cache memory controller 300.

When multiple access masters 1 are connected to the cache memory controller 300, the process switching unit 341 stores a current address A3 for each of the access masters in its memory 341a. Accordingly, if an instruction address A1#1 or A1#2 input from connected access master 1#1 or 1#2 is an address included in the instruction area 190 shown in FIG. 7, the process switching unit 341 stores it in memory 341a as the current address A3 of the access master 1#1 or 1#2 from which the instruction address was input, or if the current address A3 of the access master 1#1 or 1#2 has already been stored, the process switching unit 341 updates the stored value. Then the process switching unit 341 outputs, to the priority determination unit 347, the instruction address stored as the current address A3 and an access master number Mn, preset for each access master, indicating access master 1#1 or 1#2. If an instruction command C1#1 or C1#2 input from access master 1#1 or 1#2 is neither a read nor a write, the process switching unit 341 outputs instruction command C1#1 or C1#2 as a transfer scheduling command C3 to the priority determination unit 347.

Next, the priority determination unit 347 receives the transfer scheduling command C3, current address A3, and access master number Mn from the process switching unit 341. The priority determination unit 347 then stores the received access master number Mn, the starting address MM_ADDR of the continuous area referred to by the access master 1, the size H*V of the continuous area, and the starting address PROC of the instruction group constituting the function that refers to the continuous area, which are indicated by the received transfer scheduling command C3, in a memory 347a (transfer scheduling storage unit). The priority determination unit 347 also stores the received access master number Mn and received current address A3 in a memory 347b (current address storage unit). The priority determination unit 347 calculates access intervals Da on the basis of the current address of each access master 1, and determines transfer scheduling information of highest priority.

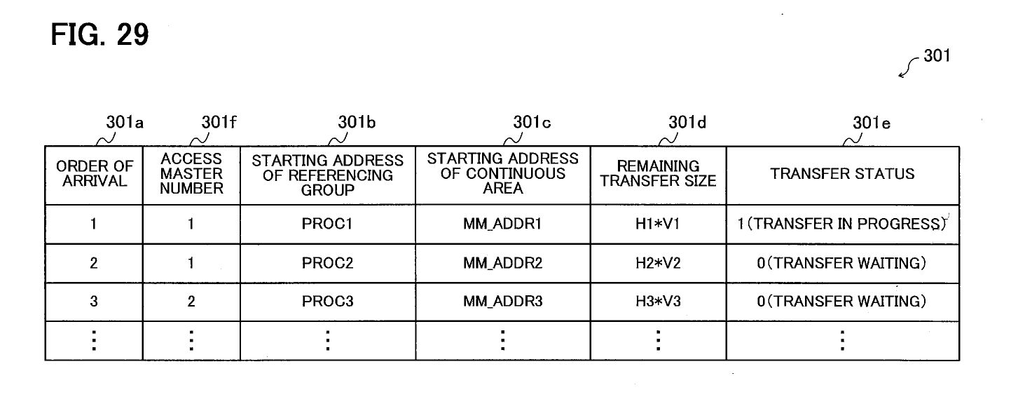

FIG. 29 is a schematic diagram showing scheduling management information 301 stored in the memory 347a in the priority determination unit 347. The scheduling management information 301 has an order of arrival column 301a, an access master number column 301f, a starting address of referencing instruction group column 301b, a starting address of continuous area column 301c, a remaining transfer size column 301d, and a transfer status column 301e. The order of arrival column 301a, starting address of referencing instruction group column 301b, starting address of continuous area column 301c, remaining transfer size column 301d, and transfer status column 301e in FIG. 29 are similar to the order of arrival column 201a, starting address of referencing instruction group column 201b, starting address of continuous area column 201c, remaining transfer size column 201d, and transfer status column 201e in FIG. 17, so descriptions will be omitted.

The access master number column 301f stores the access master number Mn supplied from the process switching unit 341.

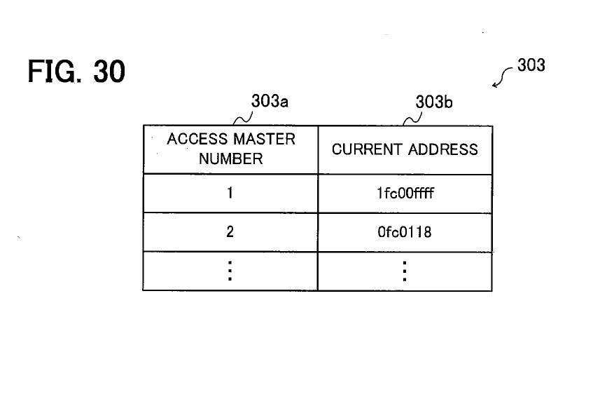

FIG. 30 is a schematic diagram showing current address management information 303 stored in the memory 347b in the priority determination unit 347. The current address management information includes an access master number column 303a and a current address column 303b.

The access master number column 303a stores access master numbers Mn supplied from the process switching unit 341.

The current address column 303b stores current addresses A3 supplied from the process switching unit 341.

A system in which a plurality of access masters 1 are connected to the cache memory controller 300 can be designed by determining the priority levels of a plurality of items of transfer scheduling information input from the plurality of access masters 1 connected to the cache memory controller 300 and enabling data transfers from the main memory 10 to the cache memory 110 to be made according to the program progress status in each access master 1, as described above. The scale of the system that is constructed can therefore be increased.

The cache memory controllers 100 to 300 described above designate a data area on the main memory 10 as a continuous area in which data to be transferred are stored, as indicated by transfer scheduling information, but this is not a limitation. The continuous area in which the data to be transferred are stored may be an instruction area on the main memory 10. In this case, the starting address PROC of the instruction group that refers to the continuous area in which the data to be transferred designated by the transfer scheduling information are stored may be the address of the instruction just before the instructions in the continuous area belonging to the instruction area on the main memory 10 from which the transfer is made are executed. Therefore, even when the access master 1 executes a branch instruction, for example, the group of instructions at the branch destination can be transferred to the cache memory 110 before being executed, preventing reduction in the operating speed of the access master 1.

The process switching unit units 141 and 341 described above switch processes by analyzing an instruction command C1 from the connected access master 1 and determining whether it is a read or a write, but this is not a limitation. For example, if the instruction command C1 input from the access master 1 is a read or a write and the address of memory 247a or 347a in the priority determination unit 247 or 347 is attached to the instruction command C1, the process switching unit units 141 or 341 may switch processes by decoding the input address. In this case, if the address attached to the instruction command C1 is not an address on the main memory 10 but the address of the memory 247a or 347a in the priority determination unit 247 or 347, the process switching unit 141 or 341 can recognize the data as transfer scheduling information. This enables the use of hardware such as a general-purpose CPU or the like as the access masters 1, and the use of a general-purpose bus, such as AMBA AXI (Advanced eXtensible Interface), for the connections between the access masters 1 and cache memory controllers 100 to 300, thereby improving the versatility of the cache memory controllers 100 to 300.

The schedule processing units 143 and 243 described above transfer addressed data from the main memory 10 to the cache memory 110 and provide scheduled area information I1 indicating a storage destination cache line to the release processing unit 144 when the hit detection result R2 is a cache miss, but this is not a limitation. For example, scheduled area information I1 indicating a storage destination cache line may also be supplied to the release processing unit 144 when the hit detection result R2 is a cache hit. In this case, when the release processing unit 144 receives the scheduled area information, it sets the access flag Fa of the cache line indicated by the scheduled area information I1, which is stored in the tag memory 121, to indicate ‘invalid’, meaning that there has been no access from the access master 1, and also sets the scheduled area access flag Fra to indicate that the access flag Fa has not become valid even once. Thus, even when it takes time for the access master 1 to begin to execute the instruction group that refers to the continuous area in which the data indicated by transfer scheduling information to be transferred are stored, the cache line will not be released and a cache hit can be ensured.

### REFERENCE CHARACTERS

1 access master, 10 main memory, 100, 200, 300 cache memory controller, 110 cache memory, 120 memory management unit, 130 hit detection unit, 140, 240, 340 data processing unit, 141, 341 process switching unit, 142 request processing unit, 143, 243 schedule processing unit, 144 release processing unit, 145 cache memory access arbitration unit, 146 main memory access arbitration unit, 247, 347 priority determination unit, 248 access management unit.

1-36. (canceled)

37. A cache memory controller connected to a main memory having an instruction area storing a first program and a data area storing data used by a specific instruction included in the first program, and to an access master for executing instructions included in the first program, the cache memory controller comprising:
a cache memory for storing a portion of the data in the main memory; and
a data processing unit that, prior to execution of the specific instruction by the access master, in accordance with transfer scheduling information including a starting address of the specific instruction and size of the data used by the specific instruction, calculates an access interval representing a number of remaining instruction steps for each unit of transfer on a basis of a number of instruction steps remaining from an address of an instruction currently being executed by the access master to the starting address of the specific instruction and, in the size of the data used by the specific instruction, remaining size of data that have not been transferred to the cache memory yet, and transfers data used by the specific instruction from the main memory to the cache memory at the calculated access interval.

38. A cache memory controller connected to a main memory having an instruction area storing a first program and a data area storing data used by a specific instruction included in the first program, and to an access master for executing instructions included in the first program, the cache memory controller comprising:
a cache memory for storing a portion of the data in the main memory; and
a data processing unit that, prior to execution of the specific instruction by the access master, and in accordance with transfer scheduling information including a starting address of the specific instruction, calculates an access interval on a basis of a number of instruction steps remaining from an address of an instruction currently being executed by the access master to the starting address of the specific instruction, and, when a plurality of items of the transfer scheduling information are processed, determines an item of transfer scheduling information of highest priority, and transfers data used by the specific instruction from the main memory to the cache memory at the access interval of the item of the transfer scheduling information of highest priority.

39. The cache memory controller of claim 38, wherein the data processing unit determines the item of transfer scheduling information of highest priority on a basis of the access interval.

40. The cache memory controller of claim 38, wherein the data processing unit receives the plurality of items of the transfer scheduling information from the access master, and determines the item of transfer scheduling information of highest priority on a basis of the access interval and a time since last access, the time since last access being a time that elapses without access from the access master to each of a predetermined plurality of continuous areas in the main memory.

41. The cache memory controller of claim 38, wherein
the data processing unit compares the access intervals calculated for the plurality of items of the transfer scheduling information received from the access master with a preset first threshold value;
when the calculated access intervals are equal to or less than the preset first threshold value, the data processing unit determines the item of transfer scheduling information of highest priority on a basis of a starting address of an instruction group that refers to a continuous area in which data to be transferred are stored,
when the calculated access intervals are greater than the preset first threshold value, the data processing unit does not determine an item of transfer scheduling information of highest priority, but defers processing until access intervals recalculated for the plurality of items of the transfer scheduling information received from the access master are equal to or less than the preset first threshold value.

42. A cache memory control method for using a cache memory to provide an access master that executes instructions included in a first program with data used by a specific instruction in the first program from a main memory having an instruction area for storing the first program and a data area for storing the data used by the specific instruction, the cache memory control method comprising:
a transfer step for, prior to execution of the specific instruction by the access master, and in accordance with transfer scheduling information including a starting address of the specific instruction, calculating an access interval on a basis of a number of instruction steps remaining from an address of an instruction currently being executed by the access master to the starting address of the specific instruction, and transferring the data used by the specific instruction, and, when a plurality of items of the transfer scheduling information are processed, determining an item of transfer scheduling information of highest priority; and
a providing step for providing the data used by the specific instruction from the cache memory to the access master when the access master executes the specific instruction.
